(19) United States
(12) Patent Application Publication
(10) Pub. No.: US 2025/0012076 A1
(43) Pub. Date: Jan. 9, 2025

(54) FIELD CONFIGURABLE LIGHTING ASSEMBLY INCORPORATING T-BAR ELEMENTS

(71) Applicant: Fusion Optix, Inc., Woburn, MA (US)

(72) Inventors: Terence Yeo, Boston, MA (US); Michael Demas, Charlestown, MA (US); Timothy Kelly, Brookline, MA (US)

(73) Assignee: Fusion Optix, Inc., Woburn, MA (US)

(21) Appl. No.: 17/976,852

(22) Filed: Oct. 30, 2022

Related U.S. Application Data
(63) Continuation-in-part of application No. 17/741,770, filed on May 11, 2022, now Pat. No. 11,921,315.
(63) Continuation-in-part of application No. 17/669,057, filed on Feb. 10, 2022.
(63) Continuation-in-part of application No. 17/669,026, filed on Feb. 10, 2022.
(63) Continuation-in-part of application No. 17/665,464, filed on Feb. 4, 2022.
Application No. 17/665,464 is a continuation-in-part of application No. 17/591,579, filed on Feb. 2, 2022.
(63) Continuation-in-part of application No. 17/713,654, filed on Apr. 5, 2022, now Pat. No. 11,885,130.
Application No. 17/713,654 is a continuation-in-part of application No. 16/877,482, filed on May 18, 2020, now Pat. No. 11,396,751.
Application No. 16/877,482 is a continuation-in-part of application No. 16/239,804, filed on Jan. 4, 2019, now abandoned.
(63) Continuation-in-part of application No. 17/693,226, filed on Mar. 11, 2022, now Pat. No. 12,055,747.
Application No. 17/693,226 is a continuation-in-part of application No. 17/476,212, filed on Sep. 15, 2021, now Pat. No. 11,543,582.
Application No. 17/476,212 is a continuation-in-part of application No. 17/107,941, filed on Nov. 30, 2020, now Pat. No. 11,163,104.
Application No. 17/107,941 is a continuation-in-part of application No. 16/039,320, filed on Jul. 18, 2018, now Pat. No. 10,852,466.
(60) Provisional application No. 63/000,718, filed on Mar. 27, 2020.
(60) Provisional application No. 63/000,649, filed on Mar. 27, 2020.
(60) Provisional application No. 62/849,199, filed on May 17, 2019.
(60) Provisional application No. 62/534,187, filed on Jul. 18, 2017.

(51) Int. Cl. E04B 9/00; E04B 9/06; F21V 7/00; F21V 21/04; F21Y 115/10

(52) U.S. Cl. CPC E04B 9/006; E04B 9/067; F21V 7/00; F21V 21/041; F21Y 2115/10

(57) ABSTRACT

Field configurable lighting assemblies integrated within a ceiling grid system are provided which are easy to assemble onsite as part of the installation process to deliver lighting distributions tailored to optimally illuminate surface ceiling panels as well as floors, walls and work surfaces below. The configurable assemblies comprises both ceiling grid components such as T-bars and ceiling panels as well as novel linear lighting modules, linear support elements, and reflectors which in some embodiments can be efficiently stacked in storage and transport to installation sites as an installation kit.

### TECHNICAL FIELD

The present disclosure generally relates to lighting assemblies, and more specifically, to a configurable modular lighting assembly for use within a ceiling grid system delivering lighting distributions tailored to optimally illuminate the ceiling surfaces as well as floors, walls and work surfaces below either directly or indirectly.

### BACKGROUND

In recent times, the implementation of lighting devices utilized in many diverse applications, such as in office workspaces, warehouses, educational institutions, research laboratories, indoor and outdoor living spaces, industrial areas, vehicles and so forth to provide illumination for humans performing visual tasks has increased drastically. Contemporarily, lighting devices are also employed for aesthetic purposes to provide a visually comforting environment to a given person. However, with the passage of time, the structural integrity of such lighting devices attributed to the structural integrity of the structural component or structure such as the structural ceiling or the ceiling grid system continues to decline. Typically, the structural integrity refers to the ability to withstand and hold together under a load, including its own weight, without breaking or deforming excessively. It assures that the ceiling grid system will perform its designed function during reasonable use, for as long as its intended life span. Typically, any object is constructed with structural integrity to prevent catastrophic failure, which can result in injuries, severe damage, death, and/or monetary losses. However, conventional ceiling grid system tend to deteriorate with time and thus significantly lose their structural integrity and thus creates a need for a ceiling grid system having a high structural integrity.

Conventionally, such lighting systems are affixed to structural ceilings, walls and other building elements for support in order to illuminate their surrounding environments. Often, a given house or building has, for a given room, a structural ceiling supporting a ceiling grid arrangement (or a ceiling grid arrangement). Typically, the ceiling grid arrangement, also referred to as being a “suspended ceiling system”, includes a plurality of tiles or panels hanging at about 30 to 50 centimeters approximately from the structural ceiling of the house or building. The ceiling grid arrangement further includes a plurality of T-Bars that are configured to hold the plurality of tiles in position. Additionally, a flush-finish of lower surfaces of the plurality of T-Bars, and the plurality of tiles by arranging each of the plurality of tiles in close contact is formed such that they appear as a continuous mono-planar ceiling surface. However, an appearance of such a conventional ceiling grid arrangement has a dull look and becomes unpleasant with passage of time and creates an unpleasant environment inside the given room of the house or building.

Moreover, the ceiling grid arrangements are provided with lighting fixtures arranged to illuminate surroundings, such as, for example a, cubical space in an office, a corridor of a house, and the like. Moreover, lighting fixtures are arranged to be supported in respect of the ceiling grid arrangements with an intention to achieve an aesthetically pleasant look. However, despite such intentions, the traditional ceiling grid arrangements are incapable of satisfying such desirable luminaires to meet the aforementioned expectations.

Major issues that are encountered with the traditional ceiling grid arrangements are a monotonous look, complex retrofitting, costlier replacements, and the like. On many occasions, an environment or workspace is provided with multiple small lighting devices, wherein the small lighting devices include multiple light sources. However, such a configuration leads to an increase in installation and maintenance costs, inefficient energy usage, wastage of resources and environmental pollution.

A further issue that is encountered with contemporary suspending ceiling arrangements is that replacing the ceiling grid arrangements, for example when generally refurbishing a given building in which a ceiling grid arrangement is installed, generates a lot of waste material that is potentially not straightforward to recycle or reuse; moreover, such waste material can be environmentally disadvantageous.

Therefore, taking the aforementioned problems into consideration, there exists a need to overcome the aforementioned drawbacks associated with the existing lighting assemblies and issues with installation of such lighting assemblies in a ceiling grid arrangement.

### SUMMARY

Throughout the present disclosure, the term “ceiling grid system” refers to any ceiling system consisting of a ceiling grid suspended or hung at a height below a structural ceiling of an architecture, such as a room of a house, or a building. It will be appreciated that the structural ceiling is an overhead interior surface that covers, namely defines, an upper limit of a room. The space between the structural ceiling and the top of the suspended ceiling grid is commonly referred to a “ceiling plenum” or “plenum space”. Common items positioned within a plenum space include HVAC ducts, HVAC vents, lighting fixtures, sprinkler heads. Typically, these are hidden from view by the ceiling grid system. Optionally, the ceiling grid system comprises a grid formation constructed using metallic bars. Furthermore, the grid formation includes pluralities of openings, wherein removable panels (ceiling panels) and/or cover elements are positioned to cover the entire structural ceiling from below. Furthermore, the grid formation is configured to accommodate various electronic and/or electrical devices for providing a plurality of services in the room. Examples of various electronic and electrical devices may include at least one of: lights, alarms, sensors, ventilation fans, heaters, humidifiers, and the like. Optionally, the ceiling grid system may include a power system for supplying electric power to the various electrically and/or electronically operated ceiling devices.

In a typical example, the structural ceiling may be at a height of 2.5 meters from a floor (not shown) of the room. In such an example, the height below the structural ceiling for holding the ceiling grid system may be 0.25 meters from the height of the structural ceiling, i.e., 2.25 meters from a floor of the room. A distance known as the “plenum height”. Furthermore, the ceiling grid system is suspended or hung at the plenum height using the hanging wires that are securely fixed to the structural ceiling. Optionally, the hanging wires can be hinged, hooked, tied, coupled, plastered securely, or fixed to the structural ceiling. In some applications it is desirable to eliminate all items from within the plenum space and minimize the plenum space to essentially zero height, a case where there is little or no space between the structural ceiling and the top of the of the ceiling grid system. This is sometimes referred to as a “zero plenum” approach.

The ceiling grid T-Bars of the ceiling grid system are hardware components such as an elongate rigid spine extending between terminal ends of the structural ceiling. Additionally, the T-Bars comprises an inverted T-shaped structure formed via the flat horizontal portion integral to the vertical portion. Furthermore, the ceiling grid T-Bars include either a fixed anchor or an adjustable anchor for attachment to an adjacent member, such as another T-Bar or other holding for securely holding or suspending the T-Bars. Optionally, the T-Bars are conjoined to the hanging wires, either by hooking, welding, gluing, and so forth. Moreover, the T-Bars include tracks or holes wherein the hanging wires can be coupled to and/or can be latched onto for supporting (i.e., for holding or suspending) the ceiling grid system from the structural ceiling. Furthermore, the T-Bars of the ceiling grid system form a series of openings into which the plurality of ceiling panels can be arranged.

In drop ceiling environments such as office spaces and residential homes, the plurality of T-Bars defining the array of T-Bar cells acts as a support grid that holds ceiling panels in place to form a drop ceiling. To form the ceiling grid, typically the T-Bars running in a first direction are long T-Bars, long enough to span an entire room (or as far as possible in case of a larger room where it is impractical to have the T-Bars spanning the entire length of the room) are used. Moreover, in a second direction, perpendicular to the first direction, shorter T-Bars are located which merely extend between adjacent long T-Bars. Additionally, apart from the plurality of ceiling panels, the T-Bars are also capable of supporting air conditioning returns and registers, as well as light fixtures and other equipment.

Furthermore, the term “ceiling panels” as used herein relates to a lightweight structure, usually a shallow cuboidal structure, having a length, a breadth, and a height which are placed within the opening formed by the T-Bars cells for covering the structural ceilings. Further, dimensions of the plurality of ceiling panels are based on the parallelepiped lattice allowed by the arrangement of the ceiling grid T-Bars to accommodate therein. Optionally, the plurality of ceiling panels are a plurality of substantially identical panels, each panel being substantially rectangular in form, when viewed from the room. Optionally, the plurality of ceiling panels includes edges, wherein, in operation, the edges of the ceiling panels rest on the horizontal-portion of the T-Bars. Optionally, the plurality of ceiling panels include at least one edge having one or more lengthwise protruding lips and/or one or more lengthwise grooves along the whole length of the edge. The protruding lips and/or one or more lengthwise grooves of the plurality of ceiling panels enable the ceiling panels to be securely held (namely supported) on the horizontal-portion of the T-Bars. The horizontal portions of the ceiling grid T-Bars define a ceiling grid plane i.e., the ceiling grid plane for the plurality of ceiling panels. Specifically, the horizontal portions of the T-Bars define the ceiling grid plane for the plurality of ceiling panels.

Two primary types of ceiling panels are typically used in suspended ceiling systems, acoustical ceiling panel and drywall ceiling, and the transition between them in the illustrated configuration. Drywall ceiling panels, also known as plasterboard, sheet rock, gypsum board, or gypsum panel, are typically comprised of a mixture comprising calcium sulfate dihydrate (gypsum) and fibrous material sandwiched between thick sheets of paper. Typically, they are cut to size as needed from large sheets and attached to a ceiling grid by means of adapter clips and fasteners such as screws. After installation they are typically coated with some form of drywall coating, typically gypsum based, to fill in void spaces and planarize the surface, often as a substrate for painting. Drywall coating can optionally be applied in a manner creating a textured surface which may be aesthetically desirable in some applications. The combination of drywall, drywall coating, and painting can provide a wide variety of desirable aesthetic finishes which can be customized at the installed location. Acoustic ceiling panels are typically prefabricated gypsum panels sized to lay in ceiling grid systems supported on edges by ledges within the grid system such as horizontal flanges of T-Bars. They are typically smaller is size and more porous and lighter weight than drywall ceiling panels and can be easily added to or removed from a ceiling grid system.

The term “ceiling mount” refers to different types of mountings applied to the structural ceiling instead of the conventional ceiling panel for a desired functioning and operation of the ceiling grid system. The ceiling mount may be replaced instead of the assembly ceiling panel using one of a decorative mount, a functional mount, or a mounting device and the like depending upon the implementation. For example, the ceiling mount may be a decorative tile, an exhaust or intake vent, a ceiling fan, a ceiling air conditioner, a ceiling glass and the like to at least cover the opening and optionally, at the same time, perform other desired operations.

The term “ceiling grid plane” used herein refers to an imaginary plane, parallel to a floor or flooring surface of the given room, along which typically conventional ceiling panels are arranged. Further, in or along the ceiling grid plane, the conventional ceiling panels are positioned or arranged mutually adjacent and parallel to each other. Furthermore, each of the horizontal portion of the T-Bars are planar and parallel to each other. Furthermore, each of the horizontal portion being in the same plane (i.e., the ceiling grid plane) provides a planar structure at lower surfaces of the T-Bars arrangement. Moreover, the planar structure at lower surfaces of the T-Bars arrangement also provides the ceiling grid plane.

The term “linear support element” refers to a continuous solid elongate structure including a shape that is configured to hold the plurality of ceiling panels and either replace a T-Bar or mount securely onto the T-Bars. The linear support element (or elongate supporting element) is typically arranged parallel to the edge of the ceiling grid T-Bars that constitute or define the at least one T-Bar cell. The linear support element may also be referred to as a support housing attributed to the functionality of the linear support element to hold and/or support multiple ceiling elements. Furthermore, the linear support element is fabricated in a manner for differently positioning the ceiling panels with respect to the ceiling grid plane. Additionally, each of the linear support element is fabricated from various elements (i.e., linear and lateral linear support elements). For example, the various elements can be continuous straight or curved bars, beams, planks, and the like. Optionally, the various elements can be detachably coupled for forming the at least one linear support element. Alternatively, the linear support element has monolithic structures i.e., a continuous structure that is fashioned out of a block; furthermore, the block can be block of metal, alloy, plastics material, wood, and the like. Additionally, materials for manufacturing the linear support element may include metals, metal alloys, hardened polyvinyl materials, and the like. Furthermore, the various elements are positioned linearly and laterally to form a structure that enables the at least one linear support element to hold plurality of ceiling panel and electrically and/or electronically operated ceiling device. Furthermore, the various elements are positioned linearly and laterally, to form a recess structure to accommodate the plurality of ceiling panels and electrically and/or electronically operated ceiling devices.

The term “lighting module” refers to a lighting arrangement comprising various electrical and/or electronic components for providing different types and intensities of illumination to the associated room, wherein the lighting module is accommodated within the assembled ceiling grid system. The lighting module body is comprised of a linear support element with end plates or covering elements mounted to each of its elongate ends. For example, different types of electrical and/or electronic components include, but is not limited to, light sources such as LEDs, at least one optical element such as a light guide, lens, diffuser, reflector and so forth. Some lighting module embodiments described in the present application enable unique ceiling grid assemblies that extend only minimally above the top of the T-Bar array but have optical cavities recessed above the ceiling rid plane. Such ceiling grid assemblies can be mounted very close to structural ceiling if desired to minimize the plenum height.

The term “covering element” refers to a type of object configured to be, or to serve, as a covering of a desired space or object. For example, the covering element may be configured to cover an opening, a space or gap, or a surface. The covering element may be shaped and sized based upon the need of the implementation i.e., the shape and size of the covering element may be configured to cover any openings present in the ceiling grid system. Typically, whenever the at least one linear support element is implemented within the ceiling grid system, to either, lower, raise or tilt the reflector with respect to the ceiling grid plane, an opening is formed. However, the opening may be formed in other manners as well without limiting the scope of the disclosure. However, such openings are not preferred since it allows the bare ceiling grid array and the ceiling grid T-Bars to be seen (by an observer on the ground) and provides an inaesthetic and/or un-appeasing look to the ceiling grid system. Further, such openings, gaps or holes may reduce the structural integrity of the ceiling grid system. Moreover, the openings may also result in collection of dust-particles and other contaminants entering via the opening. Thus, to overcome the aforementioned problem, the covering element is employed by the lighting assembly to conceal the opening to beneficially provide a monotonous, aesthetically appeasing look and at the same time increases the structural integrity of the ceiling grid system and/or the ceiling grid lighting assembly. Optionally, the covering element may also enable an air-tight formation of the ceiling grid system and/or the ceiling grid lighting assembly that does not allow air to pass through and prevent flow of dust particles therein. A covering element may be made from a variety of materials, for example; plastic, metal, glass, rubber, paper, wood, felt, recycled material, recycled PET felt, or any combination thereof. Felt materials are well suited to providing additional acoustic benefit of sound absorption. Additionally, the optical properties of the surface can be selected to control refraction, absorption, diffusion, and reflection.

The present disclosure seeks to provide an improved configurable linear lighting module for a ceiling grid system that is easier to manufacture, install and reconfigure or repair after initial installation (for example to achieve a modified functionality). Further, the improved configurable linear lighting module is inexpensive to manufacture i.e., attributed to the simplified manufacturing and design, easier to recycle or reuse when a building incorporating the ceiling grid system is being dismantled or generally refurbished. Furthermore, the present disclosure seeks to provide an improved configurable linear lighting module for providing an improved control of light fixtures and the power supply to the light fixtures. Furthermore, the present disclosure seeks to provide an improved configurable linear lighting module with a modular functional fixture that is capable of accommodating various objects such as optical elements, utility elements, light sources, power modules, speakers, and the like. Furthermore, the present disclosure seeks to provide an improved, robust and flexible lighting module by virtue of operation to cope with varying user requirements. Moreover, the present disclosure also seeks to provide an improved energy-efficient ceiling grid lighting assembly. Furthermore, the present disclosure also seems to provide a lighting module that functions like a light fixture having a unique performance and aesthetic benefits and comprises of lighting components that integrate with the ceiling grid T-Bars, which provide structural support, and the plurality of ceiling panels which in some embodiments provide light reflectance and light distribution control. The present disclosure, in some embodiments, provides a light distributing reflective cavity that includes a reflective panel; either a standard ceiling panel or an embodiment with customized reflectance properties (specular or diffuse surface, surface texture, surface geometric features, etc.) Moreover, in the present disclosure, the embodiments can be configured to create a lighting cavity, at, below, or above the ceiling grid plane.

Embodiments of the present disclosure substantially eliminate, or at least partially address, the aforementioned problems in the prior art, and provide an improved lighting assembly to provide more uniform light distribution patterns that mitigate visual discomfort and are aesthetically appealing to a given viewer. Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. When illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by matching numbers.

Embodiments of the present disclosure will now be described, by way of example only, with reference to the following diagrams:

FIG. 1A is an illustration of a ceiling grid system, in accordance with an embodiment of the present disclosure.

FIG. 1B is an illustration of the ceiling grid system, comprising at least one covering element, in accordance with an embodiment of the present disclosure.

FIG. 2 details the key elements of ceiling grid lighting assembly embodiments.

FIG. 3A is an illustration of a perspective top view of an exemplary ceiling grid system, in accordance with an embodiment of the present disclosure;

FIG. 3B is an illustration of a perspective top view of an exemplary ceiling grid system, in accordance with another embodiment of the present disclosure;

FIG. 3C is an illustration of a perspective top view of an exemplary ceiling grid system comprising a covering member, in accordance with yet another embodiment of the present disclosure;

FIGS. 4A, 5A, 6A and 7A are illustrations of perspective top views of exemplary ceiling grid systems in which a central optical cavity is partially enclosed via a reflective housing, in accordance with various other embodiments of the present disclosure;

FIGS. 4B, 5B, 6B and 7B are illustrations of perspective top views of exemplary ceiling grid systems in which the central optical cavity is completely enclosed via the reflective housing, in accordance with various other embodiments of the present disclosure;

FIG. 7C is a cross section view of a linear lighting module embodiment depicting specific details of an embodiment linear lighting module implemented in the lighting assembly embodiment.

FIGS. 8A and 8B are cross section views illustrating variations of ceiling grid lighting assembly embodiment A.

FIGS. 8C and 8D are cross section views illustrating variations of ceiling grid lighting assembly embodiment B.

FIG. 8E is a cross section view of an embodiment linear lighting module used in lighting assembly embodiments A and B and its associated components including linear support element, optical element, and LED board.

FIGS. 9A and 9B are cross section views illustrating variations of ceiling grid lighting assembly embodiment C.

FIG. 9C is a cross section view of an embodiment linear support element used in lighting assembly embodiments C and its associated components such as linear support element, optical element, and LED board.

FIGS. 10A-10B are cross section views illustrating variations of ceiling grid lighting assembly embodiment E.

FIGS. 10C-10D are cross section views illustrating variations of ceiling grid lighting assembly embodiment F.

FIG. 10E is a cross section view of a linear lighting module used in lighting assembly embodiments E and F and its associated components including linear support element, optical element, and LED board.

FIG. 10F is a cross section view of a linear lighting module with removable components.

FIG. 10G is a cross section view of a linear lighting module with angled exterior support feature.

FIGS. 11A and 11B are cross-section views of ceiling grid lighting assembly embodiment G incorporating an angled output face to the linear lighting module.

FIG. 11C is a cross section view of a linear lighting module with angled output face.

FIGS. 12A and 12B are cross section views illustrating variations of ceiling grid lighting assembly embodiment type H incorporating an arcuate shaped output face.

FIGS. 12C and 12D are cross section views illustrating variations of ceiling grid lighting assembly embodiment I with elevated horizontal output face.

FIG. 12E illustrates a cross-section view of a linear lighting module implemented in the ceiling grid lighting assembly embodiment with the covering element or end plate 1216 in assembled position

FIGS. 13A and 13B are views illustrating variations of ceiling grid lighting assembly embodiment J with angled output face.

FIG. 13C is an isometric diagram illustrating the embodiment J in a ceiling grid assembly.

FIGS. 14A and 14B are views illustrating variations of ceiling grid lighting assembly embodiment K with angled output face.

FIG. 14C is isometric diagram illustrating the embodiment K in a ceiling grid assembly.

FIGS. 15A and 15B, illustrated are bottom and top perspective views of the lighting assembly supported within a ceiling grid system.

FIG. 15C, illustrated is an exemplary linear lighting module implemented in the lighting assembly of FIG. 15A or 15B.

FIG. 15D, illustrated is a bottom perspective view of the lighting assembly of FIG. 15A or 15B.

FIG. 16A and FIG. 16B are embodiment LED light sources; FIG. 16A showing a rigid linear LED board and FIG. 16B showing a flexible strip provided on a reel and which can be cut to a required length.

FIG. 16C isometric illustrations of various embodiments of edgelit optical elements used in ceiling grid lighting assemblies.

FIG. 16D is table containing optical properties of various embodiments of edgelit optical elements.

FIG. 16E represents in polar plot form a sampling of light distribution types achievable with variously configured ceiling grid assembly embodiments.

FIG. 17A is an illustration of individual components for use in configuring and installing embodiment ceiling grid lighting assemblies in combination with an existing ceiling grid system.

FIG. 17B is an illustration of partially pre-assembled components for use in configuring and installing embodiment ceiling grid lighting assemblies in combination with an existing ceiling grid system.

FIG. 18A is an isometric below ceiling plane view of an lighting assembly reflector embodiment.

FIG. 18B is an isometric below ceiling plane view of an lighting assembly reflector embodiment.

FIG. 19 is a view of a stacking process for multiple embodiment lighting assembly reflectors of FIG. 18.

### DETAILED DESCRIPTION

The following detailed description illustrates embodiments of the present disclosure and ways in which they can be implemented. In overview, embodiments of the present disclosure are concerned with a lighting assembly to provide an aesthetically appealing appearance to the ceiling grid system and its associated lighting assembly and for providing various light distribution patterns in an environment.

Although some modes of carrying out the present disclosure have been disclosed, those skilled in the art would recognize that other embodiments for carrying out or practicing the present disclosure are also possible. Furthermore, the embodiments of the present disclosure also provide a lighting assembly which either replaces one or more T-Bars in a given ceiling grid cell or is supported by a T-Bar such as by mounting over the vertical leg of the T-Bar or by sliding along and receiving the horizontal leg of the given T-Bar.

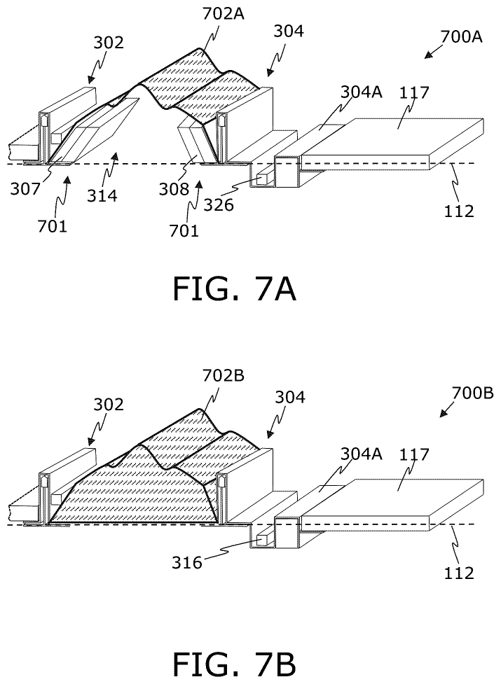

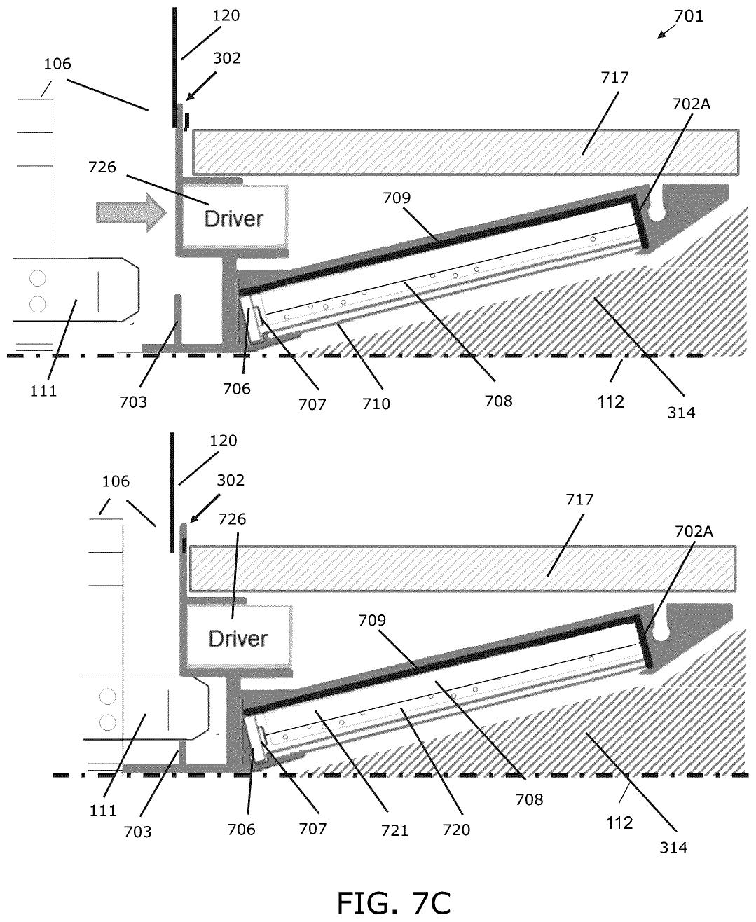

Labeled items of illustrated lighting assembly embodiments FIGS. 7-17 are as follows wherein “XX” indicates the Figure number;
100 Ceiling Grid System
104 T-bar Cell
106 T-Bar
106C Central T-Bar
107 T-Bar Height (“Zero Plenum Height”)
108 T-Bar Horizontal Portion
110 T-Bar Vertical Portion
111 T-Bar Anchor
116 Structural Ceiling
117 Surrounding Ceiling Panel
120 Suspension Cable or Wire
XX00 Ceiling Grid Lighting Assembly
XX01 Linear Lighting Module
XX02 Linear Support Element
XX03 T-Bar Feature on Linear Support Element
XX04 Support feature of Linear Support Element
XX05 Optical Assembly (LED, Board, Optics)
XX06 Printed Circuit Board (PCB)
XX07 Light Emitting Diode (LED)
XX08 Primary Optical Element
XX09 Reflector
XX10 Secondary lens
XX12 Ceiling Grid Plane
XX13 Electrical Connector
XX15 Outer optical lens
XX14 Optical Cavity
XX16 Covering Element
XX18 Assembly ceiling panel
XX19 Reflector Support Flange
XX20 End Plate or End Cap
XX21 End Plate Hole
XX22 T-Bar Mounting Feature or Bracket
XX24 Ceiling Panel Support Feature
XX26 Power Source/Driver
XX28 Utility Component
XX30 Optical Element Light Distribution
XX57 Non-Optical Cavity
532 T-bar Hole
555 Fastener
536 Vertical Alignment Tab

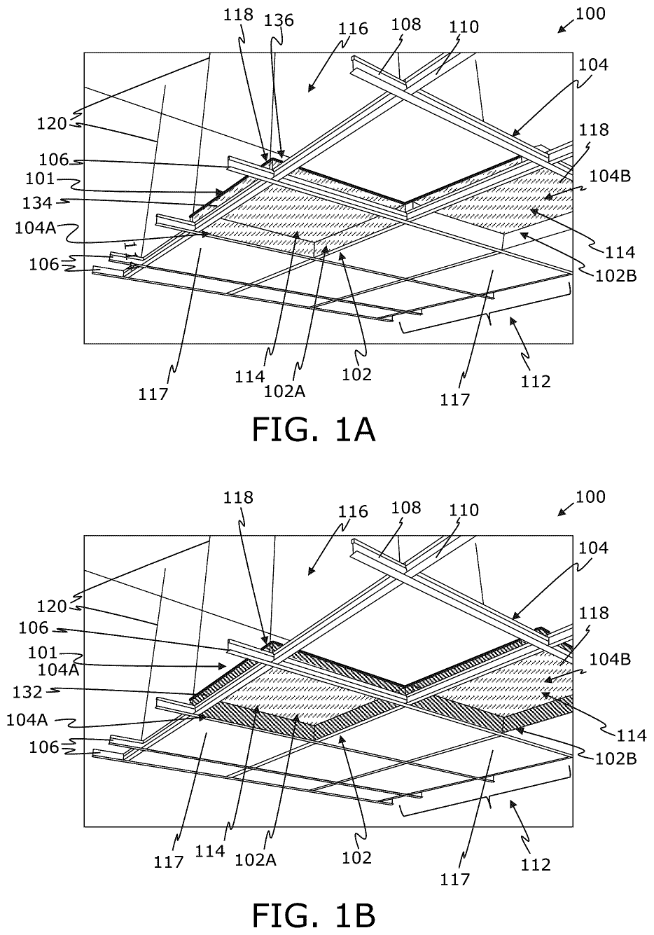

FIG. 1A and FIG. 1B are illustrations of an overall ceiling grid system (also referred to as a suspended ceiling system), which contains various embodiments 100A, 100B of the modular ceiling grid lighting assembly wherein FIG. 1A shows embodiment assemblies without covering elements and FIG. 1B shows embodiment assemblies with covering elements. Notably, the differentiating feature of FIG. 1B of the present disclosure is depicted with a closed or covered perspective view whereas the open view (i.e., FIG. 1A) is illustrated to depict the common configuration therein and thus illustrates a view that does not cover any openings or gaps in the ceiling grid system 100.

The ceiling grid system comprises several ceiling grid lighting assembly 100 (later shown in greater detail of various embodiments) for providing the required illumination in the room or structure within which the ceiling grid system is located.

As shown, in FIGS. 1A and 1B, the ceiling grid system 100 comprises the array of T-bar cells 104 having ceiling grid T-bars 106 (also referred to as simply T-bars), wherein each of the ceiling grid T-bars 106 have flat end-portions i.e., horizontal portions 110 and vertical portions 108. Further, the plane containing the horizontal portions 110 of the ceiling grid T-bars 106 defines a ceiling grid plane 112, wherein the ceiling grid plane 112 also defines the array of T-bar cells 104. The term “ceiling grid plane” used herein refers to an imaginary plane, parallel to a floor or flooring surface of the given room, along which typically conventional ceiling panels are arranged. As may be seen, in or along the ceiling grid plane 112, the ceiling grid T-bars 106 are positioned or arranged mutually adjacent and parallel to each other. Furthermore, each of the horizontal portions 110 of the T-bars 106 are planar and parallel to each other. Herein, each of the horizontal portions 110 being in the same plane (i.e., the ceiling grid plane 112) provides a planar structure at lower surfaces of the T-bars 106 arrangement. Also, herein, the planar structure at lower surfaces of the T-bars 106 arrangement also defines the ceiling grid plane 112. Herein, the lighting assembly 100 is configured to provide illumination to the associated room. For example, each T-bar cell of the array of T-bar cells 104 is configured to support a lighting assembly 100 therein. Further shown, the ceiling grid T-bars 106 and/or the array of T-bar cells 104 of the ceiling grid system 100 are supported by hanging wires 120 coupled to a structural ceiling 116 of the room associated with the ceiling grid system 100. Notably, the lighting assembly 100 is supported or mounted within the ceiling grid system to provide the required illumination or light distribution, wherein the lighting assembly 100 may be supported in a plurality of manners with one or more elements. In an example, the lighting assembly 100 may be supported or mounted linearly along a length of the ceiling grid T-bars 106. In another example, the lighting assembly 100 may be supported or mounted on a supporting element. In another example, the lighting assembly 100 may be mounted in place of shorted ceiling grid T-bars 106. In another example, the lighting assembly 100 may be directly supported or mounted on the ceiling grid T-bar such as via a hook or spring. In another example, the lighting assembly 100 may be supported or mounted via only the end-portions of the lighting assembly 100 being supported thereat. It will be appreciated that the lighting assembly 100 may be directly or indirectly supported or mounted withing the ceiling grid system via any type of mechanical coupling or a detachable coupling without limiting the scope of the disclosure.

Further shown, in FIGS. 1A and 1i, the lighting assembly 100 within the ceiling grid system implements T-bar cells 104A, 104B from amongst the T-bar grid array 104 (also referred to as the array of T-bar cells) that provides structural integrity to the lighting assembly 100. Typically, the T-bar cell 104A, B is configured to provide structural integrity the lighting assembly 102 by firmly and reliably accommodating the lighting assembly 102 therein. Since, the lighting assembly 100 is directly supported by the T-bar cell 104A, the lighting assembly 100 is more reliable and safer to use due to the high structural integrity imparted to the lighting assembly 100 via the T-bar cell 104A of the array of T-bar cells 104.

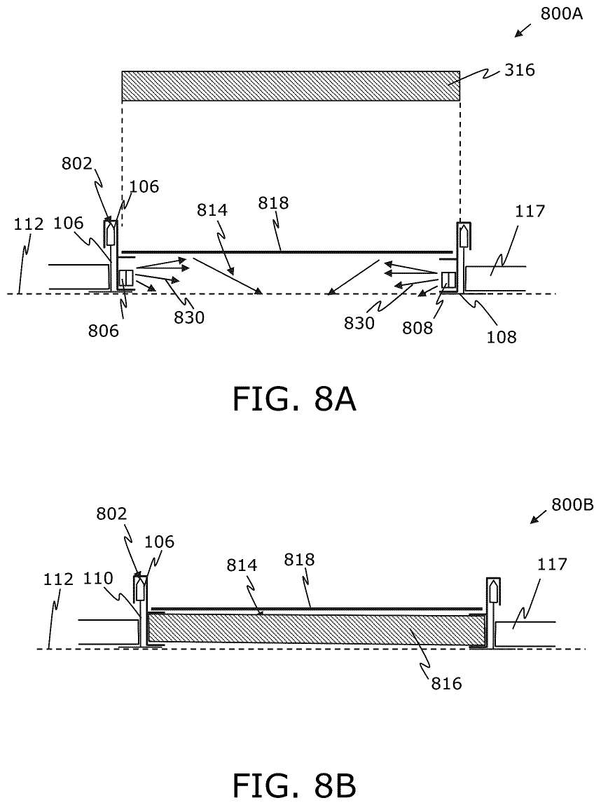

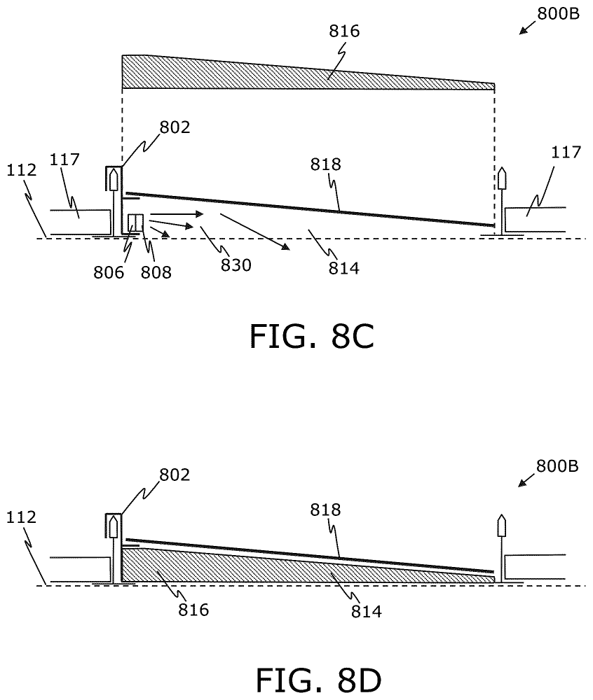

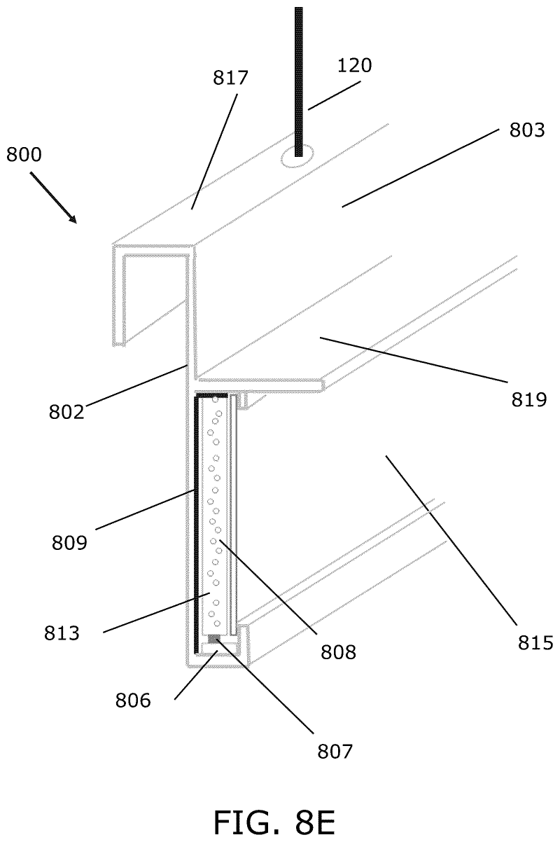

As shown in FIGS. 1A and 1, in combination with FIGS. 8A-14B, the lighting assembly 100 comprises at least one linear lighting module 101, supported on at least one T-bar cell 104A from amongst the array of T-bar cells 104 that provides structural integrity to the lighting assembly 100. Typically, the at least one T-bar cell 104A is configured to support the lighting assembly 100 thereat, and wherein the lighting assembly 100 comprises the at least one linear lighting module 101. In the illustrated example, the lighting assembly 102 has been shown to include two linear lighting modules 102A and 102B therein supported on the T-bar cell 104A and 104B, respectively.

The at least one linear lighting module 101 comprises at least one linear supporting element 102 configured to be arranged on the ceiling grid T-bars 106 defining the at least one T-bar cell 104A. The linear supporting element 102 (or elongate supporting element) is arranged parallel to an edge of the ceiling grid T-bars 106 that constitute or define the at least one T-bar cell 104A. The at least one linear support element 102 configured to be arranged onto a mounting T-bar within the at least one T-Bar cell 104A, wherein the at least one linear support element 102 comprises an elongate body configured to support and align the components of the at least one linear lighting module 101. The at least one linear supporting element 102 may be referred to as a support housing attributed to the functionality of the linear supporting element 102 to hold and/or support multiple ceiling elements. Furthermore, the at least one linear supporting element 120 is fabricated in a manner for differently positioning the elements of the lighting assembly 100 with respect to the ceiling grid plane 112.

Further, the at least one linear lighting module 101 further comprises at least one optical assembly 105 that may be supported on at least one of the at least one supporting element 102 or directly on the T-bars 106. Typically, the optical assembly 105 comprises at least one LED light source 122, at least one printed circuit board (not shown) i.e., associated with supply of electricity from any power source, and at least one optical element 124.

Embodiment light sources 122 in the ceiling grid lighting assembly 100 embodiments of comprise at least one of, a LED light, an incandescent light, a monochromatic light, a laser, and a combination thereof. The most typical embodiments are of a linear array of LED light sources arranged on LED boards which can be rigid printed circuit board (PCB) or flexible and selectively cut to length in a “tape-like” format.

Typically, an optical element 124 of the optical assembly 105 comprises at least one of: a light guide, an edgelit diffuser, a direct lit diffuser, a reflector, a refractive lens, a diffractive lens. As represented, a light guide is an optical element which has one or more input faces along its edges into which light from a light source enters and utilizes internal reflection to propagate a portion of light within the optical element by multiple internal reflections while simultaneously outcoupling a portion of light, typically light guides have high transmission (>90%), low haze (<1%) and high clarity (>99%). An edgelit diffuser is also lit from one or more of its edges but its primary function is to diffuse or scatter any light that enters into its bulk material. An edgelit diffuser significantly has much lower clarity than a light guide (typically less than 50%) and much higher haze (typically more than 50%). The edgelit diffuser can further comprise a combination of internal light scattering and light redirecting surface features. The light redirecting features may be regular, such as lines or ridges, or could be a random pattern. Edgelit diffusers also typically have much high lower levels of surface gloss than light guides. This is because the outer surfaces are not required to allow total internal reflection as is the case with light guide materials. In other embodiments, the optical element can be implemented as a bent mirror that reflects light incident thereon along a first path (and at a first angle) along a second path (and at a second angle) different from the first path. A direct lit diffuser is another optical element wherein light is incident upon the largest area face of the optical element and light is transmitted through the direct lit diffuser lens that scatters light, diffuses light or enables reduction in intensity of light.

As shown, in FIGS. 1A and 1, the ceiling grid system comprises an array of T-Bar cells 104 having ceiling grid T-Bars 106 (also referred to as T-Bars), wherein each of the ceiling grid T-Bars 106 have flat end-portions i.e., horizontal portions 110 and vertical portions 108. Further, the plane containing the horizontal portions 110 of the ceiling grid T-Bars 106 defines a ceiling grid plane 112, wherein the ceiling grid plane 112 also defines the array of T-Bar cells 104. Moreover, the ceiling grid system 100 also comprises hanging wires 120 coupled to a structural ceiling 116 configured for providing structural integrity to the ceiling grid system 100.

Typically, the ceiling grid lighting assembly 100 comprises the linear lighting module comprising a linear support element 102 with integrated or removable optical assemblies 105 to be supported by the ceiling grid T-Bars 106 and configured to provide illumination to the room associated with the ceiling grid system.

Further shown, in FIGS. 1A and 1, the linear support element 102 within the ceiling grid system couples to at least one T-Bar cell 104A within the T-Bar grid array 104 (also referred to as the array of T-Bar cells) that provides structural integrity to the ceiling grid lighting assembly 101. Typically, the at least one T-Bar cell 104A is configured to provide structural integrity the linear support element 102 by firmly and reliably accommodating the ceiling grid lighting assembly 100 therein. Since, the linear support element 102 is directly supported by the at least one T-Bar cell 104A, the ceiling grid lighting assembly 100 is more reliable and safer to use due to the high structural integrity imparted to the ceiling grid lighting assembly 101 via the at least one T-Bar cell 104A of the array of T-Bar cells 104.

The ceiling grid lighting assembly 100 further comprises at least one linear lighting module 101 supported on the at least one T-bar cell 104A from amongst the array of T-bar cells 104. The linear lighting module 101 comprises multiple electrical, optical and/or mechanical components to collectively form a module of the lighting assembly 100. Typically, the at least one linear lighting module 101 comprises of at least one supporting element 102 and at least one optical assembly 103. Herein, the at least one linear support element 102 is configured to be arranged parallel to an edge of the ceiling grid T-Bars 106 defining the at least one T-Bar cell 104A. Typically, the edge of the ceiling grid T-Bars 106 may be the horizontal portion 110 of the ceiling grid T-Bar 106, wherein the linear support element 102 extends along and parallel to the edge of the T-Bars 106.

In an embodiment, the at least one linear support element 102 is detachably coupled to the ceiling grid T-Bars 106. Typically, the at least one linear support element 102 forms a detachable coupling with the ceiling grid T-Bars 106, and thus allows a quick and easy replacement of any of the coupled ceiling grid-T-Bars 106 without replacing the entire ceiling grid system 100.

In an embodiment, the at least one linear support element 102 comprises a clip, bracket, or latch to detachably couple with the ceiling grid T-Bars 106. Typically, the clip, bracket or latch of the at least one linear support element 102 is configured to provide the detachable coupling with the T-Bars 106. The ceiling grid lighting assembly of the present disclosure eliminates a need and cost for brackets or other mounting or suspension hardware and does not require any cutting of ceiling panels in the ceiling grid arrangement. The ceiling grid lighting assembly allows to provide for the length of the light fixture that matches the length of the T-Bar, or it could be lesser or greater than the length as desired for aesthetic purposes. Furthermore, the present ceiling grid lighting assembly 101 provides for fixtures of shorter lengths that could be used together to provide a configurable overall length, and further can be used to combine fixtures such as spotlights and wall washers.

Further, as shown in FIGS. 1A and 1, the lighting assembly 100 further comprises a reflector 118 or an internal reflecting surface configured to be arranged on at least one of the at least one linear support element 102 or the ceiling grid T-bars 106 to form a central optical cavity 114 within the at least one T-bar cell 104A and above the ceiling grid plane 112, wherein the reflector 118 extends toward the ceiling grid plane 112 to partially or completely enclose the central optical cavity 114. Herein, the reflector is shaped in a manner so as to provide superior stacking capabilities to the reflector to minimize and/or optimize the occupied space during storage of the reflectors 118 and also shaped to optimally illuminate the entirety of the room containing the lighting assembly 100.

Further, as shown in FIGS. 1A and 1B, the at least one linear support element 102 is mounted in operation on the ceiling grid T-Bars 106, wherein the at least one linear support element 102 is configured to support the reflector 118 thereon along with the T-Bars 106. The at least one linear support element 102, when in operation, supports the reflector 118 higher than the ceiling grid plane 112. Specifically, the at least one linear support element 102 hold the edges of the reflector 118 in a manner that the position of the reflector 118 is raised relative to the ceiling grid plane 112. Furthermore, the position of the reflector 118 that is higher than the ceiling grid plane 112 can be defined as a condition, wherein an axis of abscissas of the reflector 118 is parallel to an axis of abscissas of the ceiling grid plane 112 when measured in a plane cartesian coordinate system. Optionally, the reflector 118 higher than the ceiling grid plane 112 includes a height that is more than a height of the ceiling grid plane 112. It will be appreciated that the heights of the reflector 118 and the ceiling grid plane 112 are measured from the floor of the given room. For example, the height of the at least one reflector 118 may be 2.25 meters from the floor. In such an example, the at least one linear support element 102 holds the reflector 118 at a height of 2.30 meters from the floor of the room. Beneficially, such a provision of support from the at least one linear support element 102 enables the reflector 118 to be oriented either parallel to the ceiling grid plane 112 or inclined at a desired angle with respect to the ceiling grid plane 112, wherein the angle ranges from 0 to 90 degrees.

The at least one linear support element 102, when in operation, supports the reflector 118 of the reflector 118 at a tilted angle relative to the ceiling grid plane 112. Optionally, the at least one linear support element 102 holds an edge of the reflector 118 at a position that is higher than the ceiling grid plane 112 and another edge of the reflector 118 at a position that is lower than the ceiling grid plane 112. Optionally, the at least one linear support element 102 holds an edge of the reflector 118 a position that is higher than the ceiling grid plane 112 and another edge of the reflector 118 is held on the ceiling grid plane 112. More optionally, the at least one linear support element 102 holds an edge of the reflector 118 at a position that is lower than the ceiling grid plane 112 and another edge of the reflector 118 is held on the ceiling grid plane 112. In an example, wherein the at least one linear support element 102 holds the reflector 118 at a tilted angle relative to the ceiling grid plane 112, wherein a height of at least one edge of the reflector 118 will be more than a height of the ceiling grid plane 112, and a height of at least one edge will be less than a height of the ceiling grid plane 112. Moreover, the edge having the greater height from the ceiling grid plane 112 is located opposite to the edge having the lesser height from the ceiling grid plane 112. For example, the height of the reflector 118 may be 2.25 meters from the floor. In such an example, the at least one linear support element 102 holds the reflector 118 in a manner that an edge of the reflector 118 is at a height of 2.30 meters, and the opposite edge is at a height of 2.20 meters from the floor of the room, respectively.

However, it will be appreciated that the positioning and inclination of the reflector 118 with respect to the ceiling grid plane 112 may be beneficially varied without limiting the scope of the disclosure. Alternatively stated, the ceiling grid lighting assembly incorporates linear lighting modules 101 comprising the linear support element 102 that, when in operation, supports the reflector 118 in at least one of higher than the ceiling grid plane 112, lower than the ceiling grid plane 112 and at a tilted angle relative to the ceiling grid plane 112.

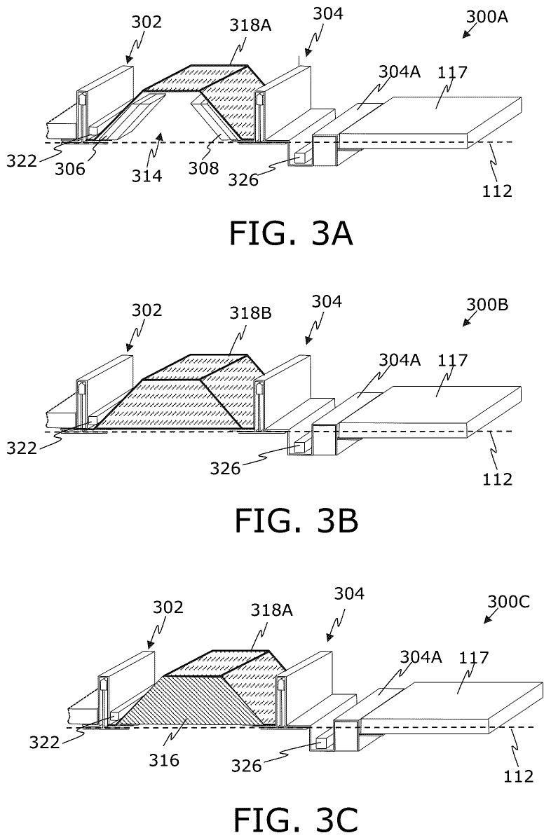

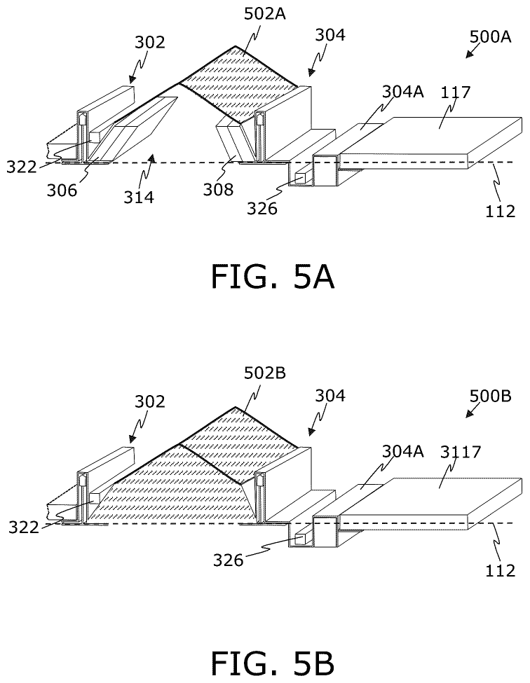

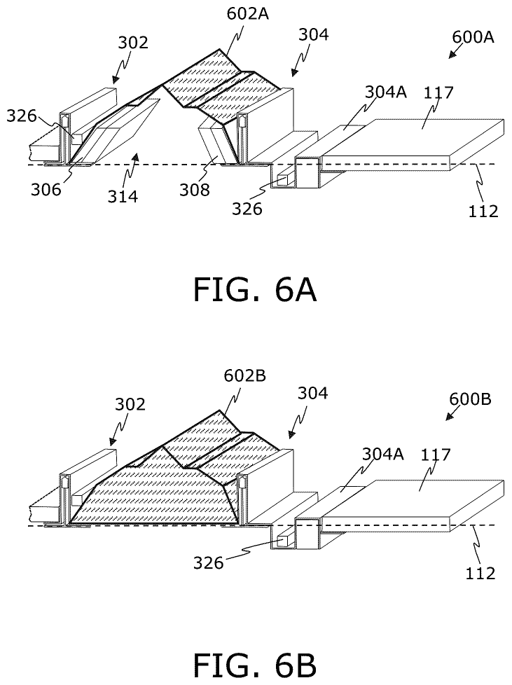

The reflector 118 supported by the at least one linear support element 102 is configured (namely arranged when in operation) to provide a three-dimensional appearance (as illustrated later in FIGS. 3A to 12B) to the ceiling grid system 100. The reflector 118 and the electrically and/or electronically operated ceiling devices are optionally arranged in a manner that their respective positions are higher than the ceiling grid plane 112, or at a tilted angle relative to the ceiling grid plane 112; in such an example, the three-dimensional appearance to the ceiling grid system is achieved. The at least one linear support element 102 accommodates the reflector 118 and electrically and/or electronically operated ceiling devices in a manner that, when in operation, the lighting assembly 100 comprises a three-dimensional view when viewed from plurality of locations within the room. It will be appreciated that, the three-dimensional appearance of the lighting assembly 100 refers to a view, wherein the ceiling grid system appears to include protrusions and indentions in height, weight, and length.

Further, as shown in FIGS. 1A and 1B, the reflector 118 (or an internal reflecting surface) configured to be arranged on at least one of the at least one linear support element 102 or the ceiling grid T-bars 106 to form the central optical cavity 114 within the at least one T-bar cell 104A and above the ceiling grid plane 112, wherein the reflector 118 extends toward the ceiling grid plane 112 to partially or completely enclose the central optical cavity 114.

Specifically, as shown, the reflectors 118 are configured to cover at least partially or completely the central optical cavity 114 formed within the T-bar cell 104A or 104B. As shown, in the T-bar cell 104A, the reflector 118 is configured to completely enclose or cover the central optical cavity 114 formed therein i.e., cover top and side regions of the central optical cavity 114 to completely cover the visible T-bars 106 and vacant region behind the ceiling grid system 100. Further, as shown in T-bar cell 104B, the reflector 118 is configured to partially enclose the central optical cavity 114 i.e., only covers the top region of the central optical cavity 114. Further, the reflector 118 is configured to extend towards the ceiling grid plane 112 to partially or completely enclose the central optical cavity 114 and provide protective covering to the lighting assembly 102 and elements therein and at the same time enhance the light distribution 130 due to the inherent optical properties (or reflective properties) and consequently providing an improved aesthetically pleasing appearance. Moreover beneficially, the light distribution 130 from the at least one light source 122 is configured to be incident on the reflector 118, wherein the reflector 118 may potentially reflect the incident light distribution 130 to provide aesthetic lighting conditions that can be controlled to provide different designs and intensities of illumination based on the requirement.

The term “reflector,” as used herein, refers to a type of housing for the lighting assembly 102, wherein the reflector 118 comprises reflective properties to enhance and/or repurpose incident light. For example, the reflector 118 may be made up of layer(s) of a reflective material, or a layer of a reflective material applied on a non-reflective material and the like. Herein, the reflector 118 may be configured to be arranged on or proximate to at least one of the at least one linear supporting element 102 or to the ceiling grid T-bars 106. Such an arrangement of the reflector 118 on or proximate to the at least one linear supporting element 102 or the ceiling grid T-bars 106 results in the formation of the central optical cavity 114 within the T-bar cell 104A or 104B defined by the ceiling grid T-bars 106. Typically, the reflector 118 is arranged on the at least one supporting element 102 or the ceiling grid T-bars 106 to derive structural integrity therefrom and is located above the ceiling grid plane 112 to form the central optical cavity 114 within the T-bar cell 104A or 104B.

In an embodiment, the reflector 118 is configured to form the central optical cavity 114 having one of a partial or complete frustrum shape, a dome shape, a hemispherical shape, a conical shape, a cuboidal shape, a cubical shape, a trapezoidal shape, and any combination thereof. Typically, the reflector 118 comprises multiple shapes and sizes to define a different central optical cavity 114 and thus providing different types of light distributions 130 thereupon. Notably, the reflector 118 may be formed to beneficially utilize the incident angles from the light source to provide a desired light distribution 130 by controlling the intensity and spread of the distribution 130 using the different shapes and sizes of the reflector 118. Additionally, the different shapes and sizes of the reflector 118 provides a three-dimensional appearance to the lighting assembly 102 and at the same time improves the aesthetics of the lighting assembly 100.

In another embodiment, the reflector 118 comprises at least one of a surface causing total internal reflection and specular reflection. The reflector 118 comprises at least one optical property selected from multiple optical properties (or characteristics) including, but not limited to, total internal reflection, specular reflection, diffused reflection, glossy reflection, and the like. Typically, based on the need of the implementation, the reflector 118 is configured to have at least one optical property to enhance or redirect the incident light from the light source 122 to provide an improved lighting distribution 130.

In an embodiment, the reflector 118 is selected from the group consisting of a metallic mirror and a multilayer reflective mirror. Herein, the reflector 118 is selected from the group consisting of a metallic mirror and a multi-layer reflective mirror. However, it will be appreciated that the mirrors may be selected from other types of mirrors such as dielectric mirrors. The metallic mirrors are mirrors (or optical reflectors) based on a thin metal coating, produced e.g., with a vacuum evaporation or sputtering technique. The metallic coating is placed on a substrate, for example, glass (e.g., fused silica), and sometimes a metal such as copper. The metallic mirror coatings consist of thin films of aluminum, silver, or gold; less common are beryllium, copper, chrome, and various nickel/chrome alloys. Optionally, the reflector 118 comprising the metallic coating is often protected (enhanced) with an additional dielectric layer to provide a broad band of reflections having low chromatic dispersion.

In an embodiment, the at least one linear lighting module 102A further comprises a diffusing lens (not shown) positioned to redirect light reflected from the reflector 118. Upon reflecting the incident light from the at least one light source 122, the light assembly 102 comprises the diffusing lens positioned, generally, in the central optical cavity 114 to redirect the light reflected by the reflector 118. Typically, the diffusing lens is configured to scatter light, diffuse light, or enable reduction in intensity of incident light for a desired illumination level.

As shown in FIG. 1B, the ceiling grid lighting assembly 100 further comprises at least one covering element 132 arranged proximate to the linear support element 102 to conceal (or cover) an opening 134 in the central optical cavity 122. The linear support element 102 is configured to provide support to the covering element 132 for covering and/or concealing the opening 134 formed in the central optical cavity 122. Notably, the at least one covering element 132 is either arranged proximate to or adjacent to the linear support element 102 to be supported thereat or arranged on the linear support element 102 for direct support provision for the at least one covering element 132. Optionally, the at least one covering element 132 may be supported by the ceiling grid T-Bars 106 or the reflector 118. The term “at least one covering element” refers to a type of object configured to be, or to serve, as a covering of a desired space or object. For example, the at least one covering element 132 is configured to cover at least the opening 134 in the central opening cavity 122. Notably, the at least one covering element 134 does not have a definite shape or size and is varied depending upon the need of the implementation i.e., the shape and size of the openings 134 present in the ceiling grid system. Generally, the shape and size of the at least one covering element 132 is equal to the size and shape of the opening 134; However, the size and shape of the at least one covering element 132 may be different from the size and shape of the opening 134, namely the size may be larger or smaller than the opening 134 to cover the opening 134 entirely or partially, respectively. Moreover, in case of a larger size of the at least one covering element 132, it may extend to the other nearby ceiling elements to provide increased coverage and protection. Typically, whenever the at least one linear support element 102 is implemented within the ceiling grid system, to either, lower, raise or tilt the reflector 118 with respect to the ceiling grid plane 112, the opening 134 in the central optical cavity 122 is formed. However, the opening 134 may be formed in other manners as well without limiting the scope of the disclosure. However, such openings 134 are not preferred since it allows the bare ceiling grid array 104 and the ceiling grid T-Bars 106 to be seen (by an observer on the ground) and provides an unaesthetic and/or un-appeasing look to the ceiling grid system 100. Further, such openings 134, gaps or holes reduce the structural integrity of the ceiling grid system 100. Moreover, the opening 134 may also result in collection of dust-particles and other contaminants entering via the opening 134. Thus, to overcome the aforementioned problem, the ceiling grid lighting assembly 100 further comprises the at least one covering element 132 to conceal the opening 134 in the central optical cavity 122 to beneficially provide a monotonous, aesthetically appeasing look and at the same time increases the structural integrity of the ceiling grid system and/or the ceiling grid lighting assembly 100. Optionally, the covering element 132 may also enable an air-tight formation of the ceiling grid system and/or the ceiling grid lighting assembly 100 that does not allow air to pass through and prevent flow of dust particles therein.

In an embodiment, the opening 134 in the central optical cavity 122 is configured by a gap 136 between the reflector 118 and the surrounding ceiling panels 117B or the assembly ceiling panel 118 and a ceiling mount. Typically, the opening 134 in the central optical cavity 114 is formed when the location and/or orientation of the assembly ceiling panel 118 is varied with respect to the ceiling grid plane 112 and wherein, the opening 134 is configured by the gap 136 between the reflector 118 and the surrounding ceiling panels 117B or the reflector 118 and a ceiling mount. The gap 136 is formed (as visible by an observer on the ground) between two neighboring ceiling elements and is required to be covered using the at least one covering element 132. Specifically, the gap 136 defines the shape and size of the covering element 132 such that the covering element 132 completely covers the opening 134 in the central cavity 122 and does not leave any holes, gaps or openings in the ceiling grid system. The “ceiling mount” refers to different types of mountings applied to the structural ceiling 116 instead of the conventional ceiling panel for a desired functioning and operation of the ceiling grid system. The ceiling mount may be replaced instead of the assembly ceiling panel 118 using one of a decorative mount, a functional mount, or a mounting device and the like depending upon the implementation. For example, the ceiling mount may be a decorative tile, an exhaust or intake vent, a ceiling fan, a ceiling air conditioner, a ceiling glass and the like to at least cover the opening 134 in the central optical cavity 122 and optionally, at the same time, perform other desired operations.

In an embodiment, the least one covering element 132 is configured to have a size conforming to a shape of the gap 136 or bigger than the gap 136. Generally, the shape and size of the covering element 132 is bigger than the gap 136 to effectively cover the opening 134 and provide the desired aesthetic look as a result. The bigger size of the at least one covering element 132 enables other ceiling elements such as, the light source, the optical element or other utility components, to be supported by the at least one covering element. Moreover, an extended portion i.e., the portion of the at least one member left after covering the opening 134 in the central optical cavity may comprise a different material and/or property with respect to the portion of the at least one covering element 132 conforming to the shape of the gap 136, such that the extended portion may provide an improved design or increase the optical characteristics of the optical element light distribution 130.

Optionally, the at least one covering element 132 is configured to have a size smaller than the gap 136 such that the opening 134 or the gap 136 is only partially covered such that a space for implementing another ceiling element or device may be provided and also to enable ventilation in the room containing the ceiling grid system.

In an embodiment, the at least one covering element 132 is integral with the linear support element 102 or detachably coupled to the linear support element 102. The at least one cover member 132 is formed integrally with linear support element 102 such that the at least one covering element 132 is formed integrally with the linear support element i.e., forms a common element configured to cover the opening 134 in the central optical cavity 122 and at the same time support the reflector 118 thereon. Such an integral arrangement increases the structural integrity and robustness of the ceiling grid system, reduces the installation time and thus, enables a quick setup and maintenance of the ceiling grid system and ceiling elements therein. Moreover, optionally, the at least one covering element 132 is detachably coupled to the linear support element 102. Typically, the at least one linear support element 102 forms a detachable coupling with the ceiling grid T-Bars 106, and thus allows easy replacement of any of the coupled ceiling grid-T-Bars 106 without replacing the entire ceiling grid system. Moreover, such a detachable arrangement allows for a quick and cost-effective replacement process and removes the need for replacing the entire ceiling grid lighting assembly 100.

In an embodiment, the at least one covering element 132 is arranged proximate to the linear support element 102 at an angle perpendicular or oblique to the ceiling grid plane 112. Typically, the at least one covering element 132 may be arranged and oriented with respect to the ceiling grid plane based on the need of the implementation proximate to the linear support element to effectively cover the opening 134 in the central cavity 122. Herein, the at least one covering element 132 is located perpendicular or oblique to the ceiling grid plane 112 such that the opening 134 formed due to lowering, raising, or tilting of the reflector 118 via the linear support element 102 is effectively covered. However, it will be appreciated that the size, orientation, and placement of the at least one covering element 132 is changed without limiting the scope of the disclosure. For example, the at least one covering element 132 is arranged parallel to the ceiling grid plane 112. Notably, the placement and orientation of the at least one covering element 132 is beneficially varied to improve the optical element light distribution 130 via the light assembly 102 such as by providing the at least one covering element 132 having one or more optical properties such as, reflection or specular reflection properties such that the optical element light distribution 130 may be focused or spread across the room containing the ceiling grid system.

In an embodiment, the at least one covering element 132 includes a planer shape, an arcuate shape or any combination thereof. Typically, the shape of the gap 136 defines the shape and size of the opening 134 in the central optical cavity 122 and thus, to effectively cover the opening 134, the at least one covering element 132 includes multiple shapes and sizes comprising a planar shape (such as a quadrilateral shape, a triangular shape or any other polygonal shape), an arcuate shape (such as, a circular shape, a semi-circular shape, paraboloid shape, a hyperboloid shape and the like), any other curved shape that may be formed by the combination of two or more of the following shapes. The arcuate configuration comprises any curved shape that may or may not be irregular and/or symmetrical, wherein the arcuate shape and size of the at least one covering element 132 is defined by the gap 136. Additionally, optionally, the at least one covering element 132 comprises one or more patterns and/or protrusions on its surface. Such protrusions and patterns are designed in a manner so as to provide an improvised look to the ceiling grid system or the ceiling grid lighting assembly 100 and at the same time provide options to the user for selection of the covering element 132 apart from the conventional size, shape and material considerations.

In an embodiment, the at least one covering element 132 comprises at least one of an optical property of refraction, absorption, diffusion, reflection or scattering of the incident light. Typically, the at least one covering element 132 may be used in conjunction with other elements such as, the printed circuit board 1106, the optical element 304 and so forth; and thus, may be required to inhibit an optical property to beneficially provide a desired illumination therein. The optical property is at least one of refraction, absorption, diffusion, reflection or scattering of the light and wherein one or more of the optical properties of the at least one covering element 132 may be used in conjunction with other ceiling elements as per the need of the implementation. Optionally, the at least one covering element 132 comprises a reflective surface i.e., a surface capable of reflecting incident light, wherein the reflective surface comprises one of an optical property. Notably, the at least one covering element 132 may comprise more than one optical property. For example, the at least one covering element 132 may comprise the optical properties diffusing, scattering, and redirecting light i.e., the at least one covering element 132 is enabled to diffuse and/or redirect incident light. Optionally, the at least one covering element 132 comprises the reflective surface, wherein the reflective surface comprises at least one of a colored surface, a textured surface. For example, the reflective surface of the covering element 132 comprises a blue-colored surface. In another example, the reflective surface of the at least one covering element 132 comprises an angularly textured surface (such as, a surface that is configured to reflect light only when the light is incident thereon at specific angles. Optionally, such reflective surfaces are configured to reflect the light such that the light is scattered at different angles therefrom). It will be appreciated that such reflection and scattering of the incident of light in different colors and along different paths, enables to provide an aesthetically appealing ambiance within a room wherein the ceiling grid system is installed. Furthermore, such a reflection of the incident light that may be emitted from natural sources, reduces a requirement for providing artificial light within the room, thereby, allowing to reduce energy consumption (and consequently, cost thereof) for lighting purposes within the room. Optionally, the covering element 132 comprises a textured surface, wherein the textured surface comprises at least one of: a light-diffusing surface, a specular surface, and/or angularly textured surface. Optionally, the covering element 132 comprises one or more protrusions thereon that may be used for an aesthetic appeal or for providing further reflection to the incoming light in multiple directions.

In an embodiment, the reflector 118 or the least one covering element 132 is one of a standard ceiling panel, an acoustic ceiling panel, a decorative tile, a planar reflective panel or a non-planar reflective panel. Typically, the at least one covering element 132 may be formed using at least a portion of the standard ceiling panel, wherein the portion of the standard ceiling panel is shaped, and size based on the gap 136 and/or the opening 134. Further, the at least one covering element 132 may be formed using the acoustic ceiling panel that are placed and oriented strategically to improve overall light and sound quality, eliminate or at least reduce the residual sounds, act as absorbers and diffusers of sound and/or light for improving sound intelligibility. Furthermore, the at least one covering element 132 may be formed using a reflective or non-reflective panel depending upon the implementation i.e., the at least one covering element 132 may further reflect light to improve the optical element light distribution 130 or may not reflect light to prevent unwanted optical element light distribution 130 or to configure the optical element light distribution 130 via the placement and orientation of the at least one covering element 132.

In an embodiment, the least one covering element 132 is made of plastic, metal, glass, rubber, paper, wood or any combination thereof. The at least one covering element 132 can be made from a variety of materials depending upon the need of the implementation. For example, the at least one covering element 132 may be formed using a plastic (that comprises one or more polymers therein) such as PET, PVC and the like, a metal or a metal alloy such as iron, steel, aluminum, copper and the like, a glass such as, a transparent or see-through glass, a designer glass, an opaque glass and the like, a rubber such as neoprene rubber, silicon rubber, nitrile rubber, fluorosilicone rubber and the like, a wood such as, softwood or hardwood or any combination thereof to provide a sturdy and robust covering element 132 or a flexible covering element. Furthermore, the covering element 132 may incorporate additional features to enable it to be connected to the linear support element or the T-Bar. The covering element 132 might also have features, such as tabs or holes, that may enable it to be attached to a cable or wire and suspended from the structural ceiling.

In an embodiment, the ceiling grid lighting assembly 100 further comprising a utility component 128, supported by the at least one covering element 132, selected from a group consisting of an alarm, a sensor, a ventilation fan, a heater, a humidifier, an electronic controller, a battery, a wireless communication module. Typically, apart from the at least one linear support element 102, the at least one covering element 132 is also configured to support the utility component 128 therein. Notably, the utility component 128 may be located either at a back side (or invisible side) of the ceiling grid system, such that after inclusion of the at least one covering element 132, the utility component 128 is beneficially hidden by the at least one covering element 132 or on a front side (or visible side) to effectively support the utility component 128 thereon. Such an arrangement i.e., at the back side of the covering element 132 provides a continuous and aesthetically pleasing look to the ceiling grid system 100 or at the front side to provide additional functionalities to the ceiling grid lighting assembly or the ceiling grid system 100. Optionally, the sensors of the utility component 128 comprises one or more of: a smoke-detector, a proximity sensor, a light sensor, a motion sensor, and a combination thereof. In an example, there is provided a house with a multilevel security arrangement including multiple combinations of utility components 128 implemented within the ceiling grid lighting assembly 100. In the same example, other utility components 128 may also be used in the multilevel security arrangement such as the smoke-detectors may be used to provide an alarm when a fire or burning happens in the house. In another example, proximity sensors and motion sensors are used to detect strangers or movements of objects. In yet another example, light sensors may be used to detect lighting conditions such as ambient light and control the light sources accordingly.

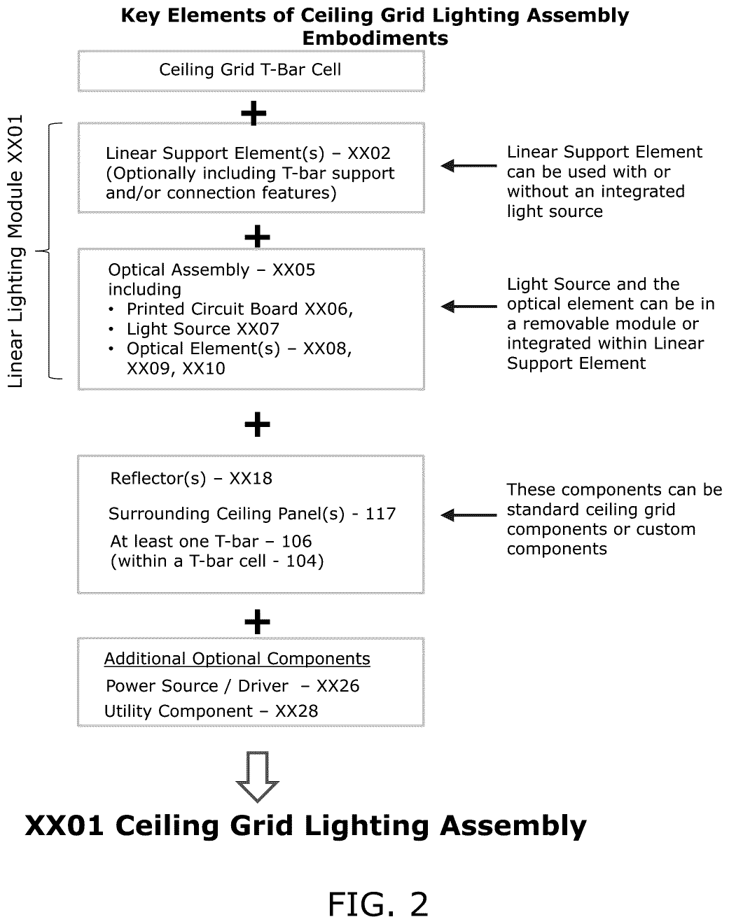

FIG. 2 is a diagram of key elements of ceiling grid lighting assembly embodiments A-K illustrated in FIGS. 3-13. reflectors, covering elements and ceiling grid T-Bars are components that can be standard ceiling grid components or custom versions. Linear support elements, light sources, and optical elements are key components that can be assembled as individual components or integrated into linear support element which can be selectively fabricated to length to fit particular ceiling grid sizes and shapes.

Referring to FIGS. 3A-3C, illustrated are perspective top views of different exemplary lighting assemblies 300A, 300B, 300C, in accordance with various embodiments of the present disclosure. As shown, the lighting assemblies 300A, 300B, 300C (similar to the lighting assembly 100) comprises the at least one linear supporting element 302, 304 (similar to the at least one supporting element 102) configured to support a reflector 318A or B thereon. Further, as shown, the reflector 318A or B comprises a hollow trapezoidal prism shape and is configured to be arranged on at least one of the at least one linear supporting element 302, 304 or the ceiling grid T-bars 106 to form a central optical cavity 314 within the T-bar cell 104A and above a ceiling grid plane 310, wherein the reflector 318A, B extends toward the ceiling grid plane 210 to partially or completely enclose the central optical cavity 218. Further, the at least one linear supporting element 204 also supports a ceiling panel 117 (i.e., the surrounding ceiling panels) thereon, such as, on a ceiling panel supporting portion 304A of the at least one supporting element 304, wherein the ceiling panel 117 is supported along the ceiling grid plane 210. It will be appreciated that, such supporting of the reflector 318A, B above the ceiling grid plane 310 and the ceiling panel 117 along the ceiling grid plane 310, along with the shape of the reflector 318A, B gives a three-dimensional appearance to the ceiling grid system 300A, 300B, 300C. Further, the at least one linear supporting element 302, 304 supports at least one light source 307 and at least one optical element 308, wherein the at least one optical element 308 receives and propagates light from the at least one light source 307 to provide the required light distribution inwardly and towards the reflector 118A, B. Moreover, the at least one linear supporting element 302, 304 further comprises a power source 326 for providing electrical power to the light source 307. Moreover, as shown, the ceiling grid system 300A, 300B, 300C comprises the central optical cavity 314 formed due to the arrangement of the reflector 318A, B above the ceiling grid plane 310. It will be appreciated that the size and shape of reflector 318A, B used in the present disclosure may be varied as per the implementational requirements without limiting the scope of the disclosure.

Referring to FIG. 3A, illustrated is a perspective top view of the exemplary lighting assembly 300A, wherein the central optical cavity 314 is partially enclosed via the reflector 318A. As shown, the reflector 318A only partially covers the central optical cavity 314 i.e., covers only a top region of the central optical cavity 314 and thus, may have limitations such as, bad aesthetics, reduced structural integrity, and dust contamination and thus an object is required to cover the central optical cavity 314 to solve the aforementioned problems.

Referring to FIG. 3B, illustrated is a perspective closed view of the exemplary lighting assembly 300B, wherein the central optical cavity 318 is completely enclosed via the reflector 318B. Typically, the reflector 318B is arranged on the linear supporting elements 302, 304 and is applied to completely cover the central optical cavity 318 to eliminate the said limitations at least partially. Notably, the shape of the reflector 318B conforms to the shape of the central opening cavity 318 and forms a trapezoidal prism. Typically, the reflector 318B is configured to be of the same size and shape of the central optical cavity 318, however, the reflecting housing 318B may be larger or bigger than the opening of the central optical cavity 318. Such a configuration of the reflector 318B provides an aesthetically appeasing look, increases the structural integrity of the ceiling grid system 300B.

Referring to FIG. 3C, illustrated is a perspective top view of the exemplary lighting assembly 300C, wherein the central optical cavity 314 is completely enclosed via the reflector 318A and at least one covering member 316, in accordance with an embodiment of the present disclosure. Typically, the at least one covering member 316 is applied when the reflector 318A partially encloses the central optical cavity 218, wherein the at least one covering member is coupled to the reflector 318A or arranged on at least one of the at least one supporting element 302, 304 or the ceiling grid T-bars 106 to conceal a gap between the reflector 318A and one of the at least one supporting element 302, 304 or the ceiling grid T-bars 106.

In configurations wherein the reflector 318A partially encloses the central optical cavity 314, a need for covering the gap between the reflector 318A and one of the at least one supporting element 302, 304 or the ceiling grid T-bars 106 is developed. Typically, to overcome the aforementioned need, the ceiling grid system 200C further comprises the at least one covering member 316 for covering the gap formed therein to completely cover the central optical cavity 314. That is, as shown in FIG. 3C, the reflector 318A only partially covers the central optical cavity 314 i.e., covers only a top region of the central optical cavity 314 and thus, may cause associated problems such as, bad aesthetics, reduced structural integrity, and dust contamination and thus an object is required to completely cover the central optical cavity 314 to solve the aforementioned problems. Thus, as further shown in FIG. 3C, as a differentiating feature from FIGS. 3A and 3B, the lighting assembly 300C further comprises at least one covering member 316 configured to completely enclose the central optical cavity 314.

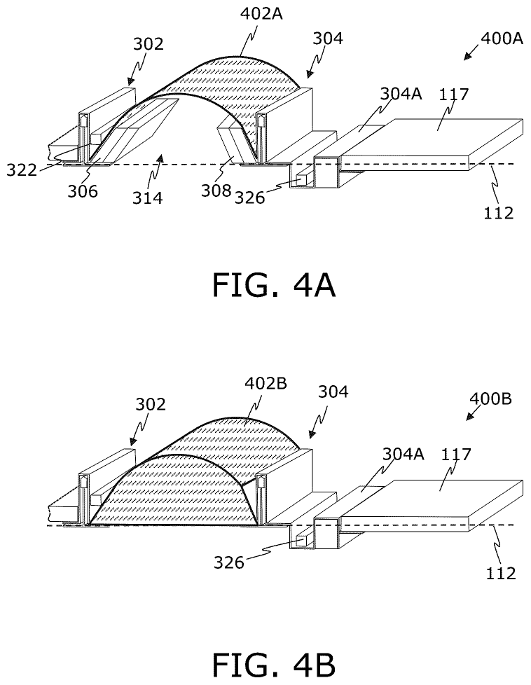

Referring to FIGS. 4A, 5A, 6A and 7A, illustrated are perspective top views of exemplary ceiling grid systems 400A, 500A, 600A, 700A wherein the central optical cavity 314 is partially enclosed via reflective housing 402A, 502A, 602A, 702A in accordance with an embodiment of the present disclosure. As shown, the ceiling grid systems 400A, 500A, 600A, 700A comprise the at least one linear supporting element 302, 304 (similar to the at least one supporting element 102) configured to support a reflective housing 402A, 502A, 602A, 702A thereon. Further, as shown, the reflective housing 402A, 502A, 602A, 702A comprises an arcuate shape of different configurations and is configured to be arranged on at least one of the at least one linear supporting element 202, 204 or the ceiling grid T-bars 106 to form a central optical cavity 218 within the T-bar cell 104A and above the ceiling grid plane 210, wherein the reflective housing 302A, 402A, 502A, 602A, 702A extends toward the ceiling grid plane 310 to partially enclose the central optical cavity 31B4. Further, the at least one linear supporting element 304 also supports a ceiling panel 117 thereon, such as, on the ceiling panel supporting portion 304A, wherein the ceiling panel 117 is supported along the ceiling grid plane 310. Optionally, the ceiling panel 208 is a reflective housing. It will be appreciated that, such supporting of the reflective housing 402A, 502A, 602A, 702A above the ceiling grid plane 210 and the ceiling panel 208 along the ceiling grid plane 210, along with the shape of the reflective housing 302A, 402A, 502A, 602A, 702A gives a three-dimensional appearance to the ceiling grid system 300A, 300B, 300C. Further, the at least one linear supporting element 302, 304 supports the at least one light source 307 and at least one optical element 308, wherein the at least one optical element 308 receives and propagates light from the at least one light source 307 to provide the required light distribution positioned inwardly and towards the reflective housing 402A, 502A, 602A, 702A. Moreover, the at least one linear supporting element 302, 304 further comprises the power source 322 for providing electrical power to the light source 307. Moreover, as shown, the ceiling grid system 400A, 500A, 600A, 700A comprises the central optical cavity 314 formed due to the arrangement of the reflective housing 402A, 502A, 602A, 700A above the ceiling grid plane 310. In operation, the light distribution from the light source 307 is incident on the reflective housing 302A, 402A, 502A, 602A, 702A for further reflection therefrom to obtain the desired light distribution. It will be appreciated that the size and shape of reflective housing 402A, 502A, 602A, 702A used in the present disclosure may be varied as per the implementational requirements without limiting the scope of the disclosure.

Referring to FIGS. 4B, 5B, 6B, and 7B illustrated are perspective top views of exemplary ceiling grid systems 400B, 500B, 600B, 700B wherein the central optical cavity is completely covered via the reflective housing 402B, 502B, 602B, 702B in accordance with an embodiment of the present disclosure. As shown, the ceiling grid systems 400B, 500B, 600B, 700B comprises the at least one linear supporting element 302, 304 (similar to the at least one supporting element 102) configured to support a reflective housing 402B, 502B, 602B, 702B thereon. Further shown, the reflective housing 402B, 502B, 602B, 702B comprises an arcuate shape of different configurations and is configured to be arranged on at least one of the at least one linear supporting element 302, 304 or the ceiling grid T-bars 106 to form the central optical cavity 314 within the T-bar cell 104A and above the ceiling grid plane 310, wherein the reflective housing 402B, 502B, 602B, 702B extends toward the ceiling grid plane 310 to completely enclose the central optical cavity. Further, the at least one linear supporting element 304 also supports the ceiling panel 117 thereon, such as, on the ceiling panel supporting portion 304A, wherein the ceiling panel 117 is supported along the ceiling grid plane 310. It will be appreciated that, such supporting of the reflective housing 402B, 502B, 602B, 700B above the ceiling grid plane 310 and the ceiling panel 117 along the ceiling grid plane 310, along with the shape of the reflective housing 402B, 502B, 602B, 702B gives a three-dimensional appearance to the lighting assemblies 300A, 300B, 300C. Further, the at least one linear supporting element 302, 304 supports the at least one light source 307 and at least one optical element 308, wherein the at least one optical element 308 receives and propagates light from the at least one light source 307 to provide the required light distribution positioned inwardly and towards the reflective housing 402B, 502B, 602B, 702B. Moreover, the at least one linear supporting element 302, 304 further comprises the power source 333 for providing electrical power to the light source 307. Moreover, as shown, the lighting assemblies 400B, 500B, 600B, 700B comprises the central optical cavity 314 formed due to the arrangement of the reflective housing 402B, 502B, 602B, 702B above the ceiling grid plane 310. In operation, the light distribution 330 from the light source 307 is incident on the reflective housing 402B, 502B, 602B, 702B for further reflection therefrom and obtained the desired light distribution. It will be appreciated that the size and shape of reflective housing 402B, 502B, 602B, 702B used in the present disclosure may be varied as per the implementational requirements without limiting the scope of the disclosure.

Referring to FIGS. 7C, illustrated are specific details of an embodiment linear lighting module 701 implemented in the lighting assembly embodiment 700A, in accordance with an embodiment of the present disclosure. As shown, the linear light module 701 and its integral linear support element 302. Further shown, A PCB 706 (with light source) inputs light into the edge of a horizontally supported low clarity edgelit diffuser 708 and light is subsequently propagated through an outer lens 715 which contains high clarity volumetric scattering and light redirecting features and is positioned at an inclined angle with respect to the ceiling grid plane 112 and the edge lit diffuser 708 which are approximately parallel to each other. The outer lens 715 changes the angular orientation and spread of the light from the edgelit diffuser 708. In the embodiment the angle is shifted more towards the vertical. Equally the outer lens 715 could shift the light more towards the horizontal. In this manner the degree of angular tilt and spread of the light can be optimized. This is very important for wall washing and cove type applications. The edgelit diffuser of FIG. 7A is a rectangular shape but an alternate embodiment is a wedge shape. A reflector 702A is positioned behind the edgelit diffuser 708 to help improve efficiency and uniformity of the light output. Additionally, a portion of the reflector 702A further wraps around a corner of the edgelit diffuser 708 to provide a reflective surface on the edgelit diffuser face that opposes the input face. In this embodiment, an LED driver 726 is further supported by the linear support element 302 on the opposing side of the T-bar 106. The linear support element 302 is further attached the structural ceiling 116 by a suspension cable 120. The linear lighting module embodiment 701 may be incorporating a horizontally support feature on the edge of the linear support element 302 that supports the edge of a reflector 718 in an adjacent position and equivalent horizontal plane to the edgelit optical element 708. The linear lighting module 701 is further configured to be securely attached to a T-Bar via a bracket which is attached using one or more mounting screws to the back of the linear support element 302. The linear support element further supports a driver 726 which is also secured using one or more mounting screws. Moreover, in the linear lighting module embodiment 701 having a wedge shaped edgelit optical element 708 and obliquely angled outer lens 715 acting as the output face of the linear lighting module. The linear support element 302 of the module 701 is further configured with an external support feature 703 configured to match the 15/16″ or 1.5″ width of a flat style T-bar and is utilized as an elongated T-bar mounting section with slot features. The slot features is configured to enable the anchor 111 of a T-bar 106 to be connected and located in an attached position. The embodiment 701 is also configured so as to be positioned in the ceiling grid between two T-bars and aligned perpendicularly to a mounting T-bar at either of its longitudinal ends and supported from its longitudinal ends either by resting on the mounting T-bar or by a supporting end plate. In this configuration the linear support element 302 is not mounted on a T-bar along its longitudinal length but rather is perpendicular to the mounting T-bar and can functionally replace a T-bar when used in a ceiling grid assembly. Furthermore, in the linear support element wherein light from a horizontally mounted edgelit low clarity diffuser 708 propagates through a second lens 715 and into the optical cavity 714. In FIG. 7D the edgelit diffuser 708 is positioned below the reflector 718.

FIGS. 8 to 15 are illustrations of exemplary implementations of lighting assemblies within a ceiling grid system, in accordance with various embodiments of the present disclosure. For each of the FIGS. 8 to 10, the “A” version figure is an open or un-covered view and the “B” version is a view with the at least one covering element in place. Typically, there will be one or more linear lighting modules each comprising a linear support element with integrated optical assembly and one or more covering elements typically on opposing sides of the assembly but with the cross-section view only the front facing covering element is visible and illustrated.

FIGS. 8A-8B are cross section views illustrating variations of ceiling grid lighting assembly embodiment 800A within a suspended ceiling grid system wherein the ceiling grid lighting assembly 800A comprises at least one T-Bar cell within the T-Bar cell array 104 that provides structural integrity to the ceiling grid lighting assembly 800A. FIGS. 8A and FIG. 8B illustrate the ceiling grid lighting assembly with and without the covering element 816 in place. FIG. 8A shows the covering element 816 removed and separately positioned above the assembly while FIG. 8B shows the covering element 816 positioned in place as part of the embodiment lighting assembly 800A wherein it functions to form an enclosing wall of the optical cavity 814 which prevents light from projecting into the ceiling plenum and aids in forming the light distribution 830 that projects out of the optical cavity 814. Although not visible and shown in the cross-section views of FIGS. 8A-D, there is typically an additional covering element in place on the opposite side of the central optical cavity from the shown covering element 816. In embodiment 800A, the optical cavity 814 is bounded by the reflector 818, covering elements 816, and the linear support element 802. The ceiling panel 117 of embodiment ceiling grid lighting assembly 800A is held horizontally by linear support elements 802 on two opposing edges and raised above the ceiling plane 812. In such an arrangement it is positioned to create a recessed central optical cavity 822 into which a portion of optical element light distributions 830 are projected from optical elements 808 which propagate light form light sources 806. Parenthetically, the printed circuit board 806 (with light source) and optical element 808 are configured to project light into and out from the optical cavity 814. As illustrated, a portion of the light from the light source 806 illuminates the underside of the reflector 818 and a portion is directed below the ceiling grid plane 810 into the room below. As illustrated in FIGS. 8A and 8B, the reflector 818 is illustrative of a standard ceiling panel size and type but alternative embodiments can be configured for panels of different size or type. The reflector 818 is held in position by an external support feature of the linear support element 802 which also supports the printed circuit board (with light sources 806) and optical elements 808 by internal support features. As illustrated, a portion 830 of the light from the light source 806 illuminates the underside of the reflector 818 and a portion 830 is directed below the ceiling grid plane 810 into the room below. In contrast to the reflector 818, the surrounding ceiling panels 117 are mounted in a conventional manner wherein the bottom surfaces of the surrounding ceiling panels 117 are resting on horizontal portions 108 of T-Bars 106 at level with the ceiling grid plane 112. The linear support element 802 further comprises internal support features 804A and 804B configured to retain and align; a horizontally supported printed circuit board on which are mounted LED light sources 806, a vertically supported edgelit optical element 808 such as a light guide or low clarity diffuser with a region or layer containing internal light scattering particles 813, a reflective surface 809 and a secondary optical element that acts as the outer lens 815 such as a light shaping diffuser.

FIGS. 8C and 8D show embodiment 800B and illustrate specific details of ceiling grid lighting assembly 800B comprising an embodiment linear support element 802 that is configured to both mount on a T-Bar and support the edge of a reflector 818 at an elevation and tilt relative to the ceiling grid plane 112. The optical element 808 is a vertically oriented edge lit diffuser configured to emit into the optical cavity and in FIG. 8C only the top mounting portion of the linear support element 802 extends minimally over the T-Bar on which it is mounted in longitudinal alignment. In FIG. 8D the ceiling grid lighting assembly 800B is illustrated with a covering element 816 in place. the linear support element 802 is configured with features of both a supporting element and a T-Bar and in this case there is no extension of components about the top of the integrated support element/T-Bar component 802. Additionally, the linear support element 802 is configured to support a driver 826 which is positioned in an adjacent T-Bar cell within the ceiling grid system, thereby eliminating a need to position the driver 826 in the plenum space above the minimum plenum plane 851.

FIG. 8E is a cross sectional view of an embodiment of a linear lighting module 801 used in ceiling grid lighting assemblies 800A and 800B and incorporating a linear support element 802 that mounts onto a T-Bar using a mounting section 817 incorporated into the elongate profile design that fits over the longitudinal length of a T-Bar vertical leg. The linear support element 802 further comprises an edgelit optical element 808 such as a light guide or low clarity diffuser with a region containing internal light scattering particles 813, a reflective surface 8 and a secondary optical element 815 such as a light shaping diffuser. The linear support element 802 further comprises a ledge 819 on which a reflector can be supported and the linear support element 802 can be securely attached to the structural ceiling 116 by using a suspension cable or wire 120 that is typically attached to a bracket or through a hole in its elongate body.

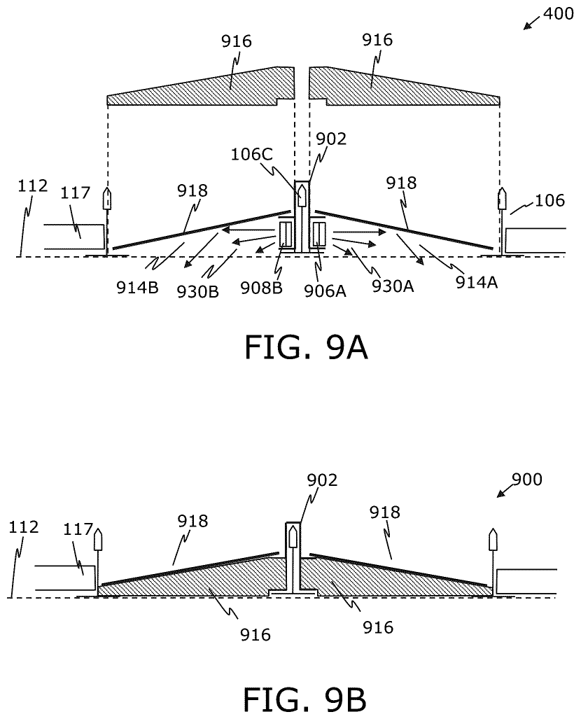

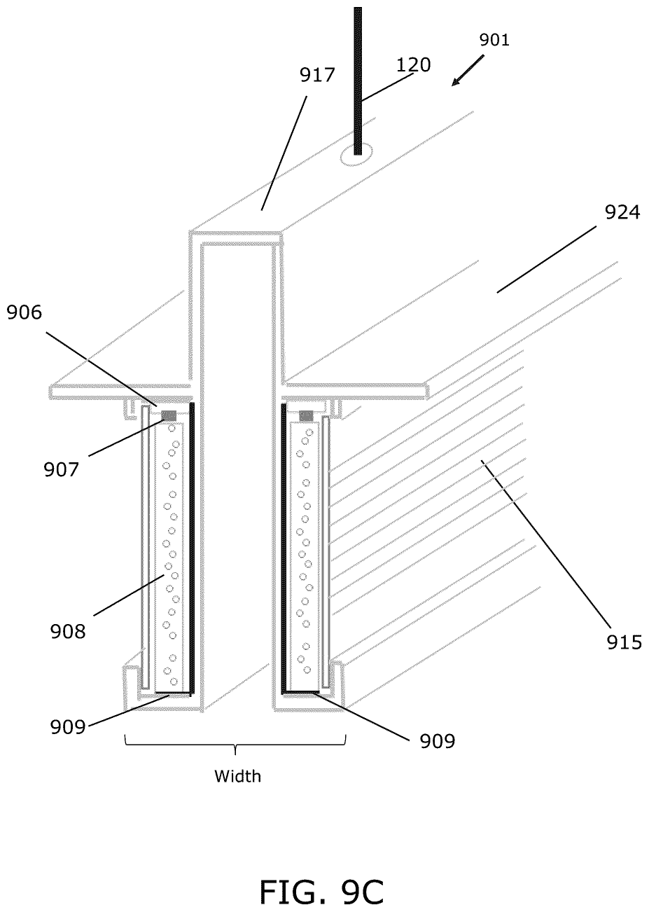

Referring to FIGS. 9A to 9C, illustrated are cross section views of lighting assembly embodiment 900, in accordance with another embodiment of the present disclosure. It will be appreciated that the FIGS. 9A-9C may be read in conjunction with FIGS. 1A-8E. As shown, wherein the lighting assembly embodiment 900 within a ceiling grid system 100, wherein the ceiling grid system 100 comprises an array of T-Bar cells 104 having ceiling grid T-Bars 106 with vertical 110 and horizontal portions 108, wherein a plane containing the horizontal portions of the ceiling grid T-Bars defines a ceiling grid plane 112, the lighting assembly 900 comprising at least one T-bar cell 104A within the T-bar grid array 104 that provides structural integrity to the lighting assembly 900. Further, the lighting assembly comprises at least one linear lighting module 901, supported on the at least one T-bar cell 104A from amongst the array of T-bar cells 104. Herein, the at least one linear lighting module 901 comprises at least one optical assembly 900 comprising at least one LED light source 906, at least one printed circuit board, and at least one optical element 908. Further, the linear lighting module 901 comprises at least one linear support element 902 configured to be arranged onto a mounting T-bar 106C within the at least one T-Bar cell 104A, wherein the at least one linear support element 902 comprises an elongate body configured to support and align the components of the at least one optical assembly 900. Furthermore, the lighting assembly 900 comprises a reflector 918 configured to be arranged on surrounding T-bars, to the at least one central T-bar 106C, of the pair of T-bar cells 104A and B or the at least one linear supporting element 902, the reflector 918 forms at least a pair of optical cavities 916A and 916B within the pair of T-bar cells 104A and 104B and above the ceiling grid plane 112, wherein the reflector 918 extends toward the ceiling grid plane 112 to partially or completely enclose the pair of optical cavities 916A and 916B. Herein, the reflectors 918 are supported by the same linear support element 902 on either side of the vertical portion of a T-Bar 106A or 106B. Furthermore, the two reflectors 918 are inclined with respect to the ceiling grid plane 112. In this case the ceiling grid assembly 900 also spans two ceiling grid T-Bar cells through the use of a linear support element 902 which straddles a central T-Bar 106C. The linear support element 902 positions printed circuit boards 906A and 906B (with light sources) and optical elements 908A and 908B on opposing sides of the central T-Bar 906C such that they produce optical element light distributions 930A and 930B that emit into respective optical cavity portions 914A and 914B and reflect off the reflectors 918 but in opposite outward directions. As illustrated, a portion of the light from the light source illuminates the underside of the reflector 918 and a portion is directed below the ceiling grid plane 112 into the room below. FIG. 8A shows two covering elements 916 positioned removed and above the ceiling grid lighting assembly 900 while FIG. 4B shows the covering element 916 in assembled position. The ceiling grid lighting assembly embodiment D can be used as a useful alternative to a typical 2×4 troffer style fixture. The tilted reflectors 918 provide a low glare and diffuse illuminated surface when viewed from the room below and the covering elements 916 positioned at each of the linear support element provide further reflected light.

FIG. 9C shows detail of a linear lighting module 901 used in the ceiling grid lighting assembly 900. In FIG. 9C the linear support element 402 is positioned on either side of the vertical portion of a T-Bar and supports and aligns one or more LED light sources 907 mounted onto a printed circuit board 906 inputting light into the edge of an optical element 908 that is a vertically oriented edgelit diffuser. The linear support element 902 further supports a reflective surface 909 behind the edgelit optical element and an optically transmissive component 915 proximate to its outer face which in turn acts as the outer face of the linear lighting module 901. In this type of configuration, a light source could be positioned on either or both edges of the edgelit diffuser and controlled independently to produce differing light distributions. FIG. 9C also shows a linear support element 902 that mounts over a T-Bar and, when mounted, supports a light source on either side of the vertical leg of the T-Bar and also incorporates reflector support features 924 to further support the edge of a ceiling panel on either side of the T-Bar. In the embodiment the optical assemblies comprise an optical element 908 that could be an edgelit low clarity diffuser or light guide. The width of the linear support element 902 is also configured to match the width of the horizontal portion 108 of the T-Bar 106 such that when it is mounted on said T-Bar 106 there is minimal overlap of the linear support element 902. The width chosen is typically 1.5″, 15/16″ or 9/16″ wide which matches the typical widths of a main beam or cross tee T-bar. The linear support element 902 can further be configured to attach to a suspension cable 120 which in turn would be attached to the structural ceiling. In this manner the linear support element is configured to be part of the structural design of the ceiling grid assembly and could be configured to support other T-Bars as well as ceiling panels.

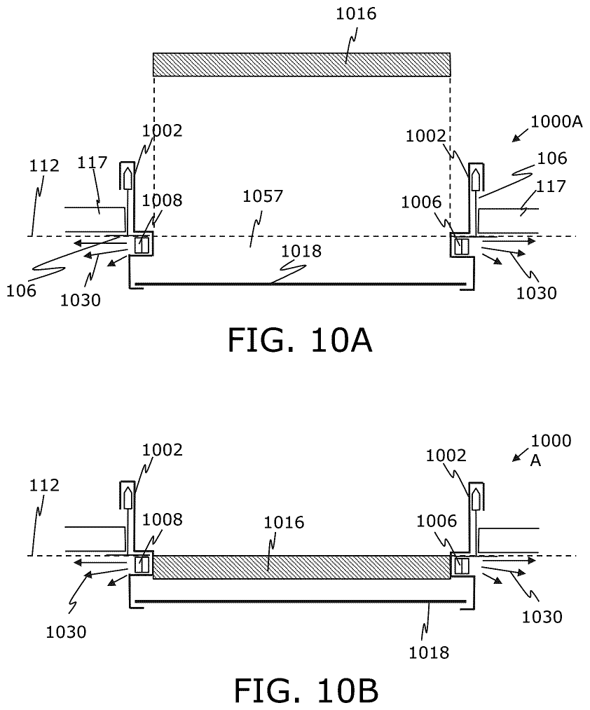

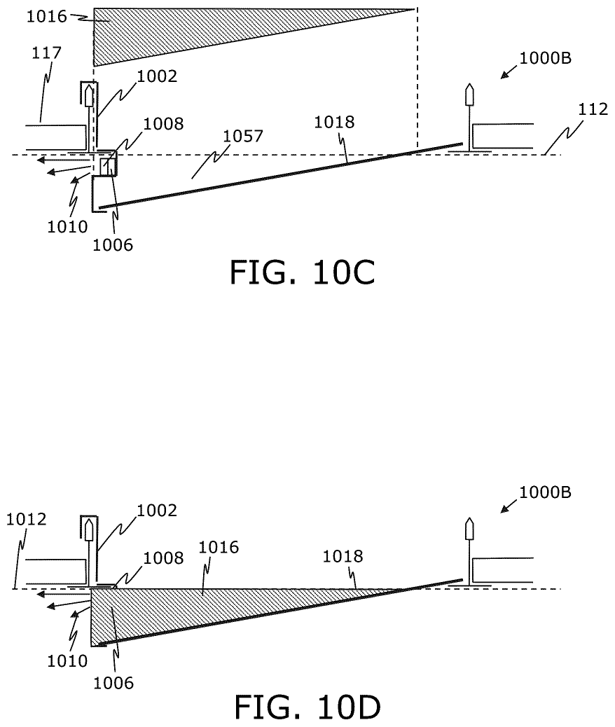

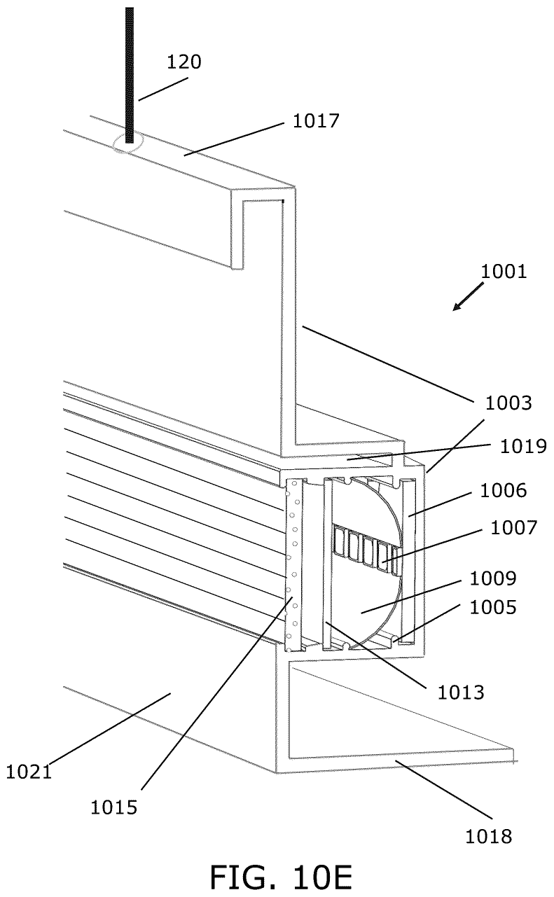

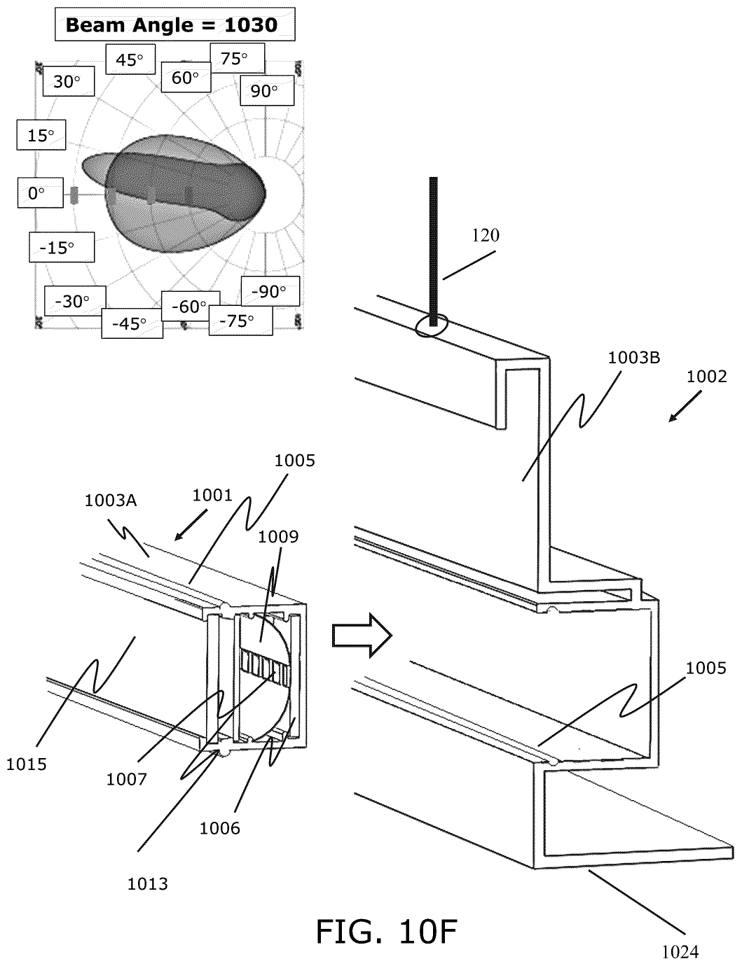

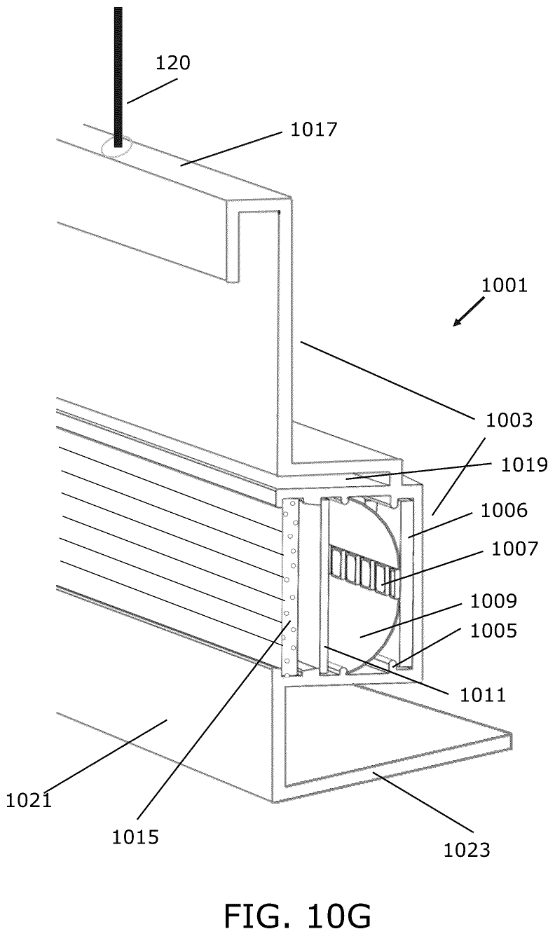

FIGS. 10A-10B views illustrating variations of ceiling grid lighting assembly embodiment 1000A within a suspended ceiling grid system wherein the ceiling panel 1018 is supported along its edges at a height that is below the ceiling grid plane 112. In embodiment 1000A there is no central optical cavity. LED light source 1007 mounted on a printed circuit board 1006, and optical element 1008 are positioned on the exterior side of a non-optical ceiling cavity 1057 formed by positioning of the assembly ceiling panel 1018 below the ceiling grid plane and below the optical elements 1008. The assembly ceiling panel 1018, covering elements 1016, and linear support elements 1002 are enclosing faces of the non-optical ceiling cavity 1057. The optical elements 1008 project the optical element light distribution away from the non-optical ceiling cavity 1057 and partially onto the surrounding ceiling panels 117. Depending on specific configuration, other portions of the optical element light distribution are projected directly downward into the room space below and/or reflected off of the linear support element 1002 or T-Bar bottom surfaces.

FIGS. 10C-10D are cross-section views of ceiling grid lighting assembly 1000B with and without covering element 1016 positioned in place as a side wall enclosure of the non-optical cavity 1057. The assembly ceiling panel 1018 is positioned at an inclined angle and with one edge at a lower elevation with respect to the ceiling grid plane 112 by the use of the linear support element 1002. Without the covering element it would be possible to see behind the ceiling panel 1018 and into the plenum space. Correspondingly, the covering element 1016 has a wedge shape in order to order to cover the triangular/wedge shape opening created by the tilted and partially lowered assembly ceiling panel 1018. Optionally, the tilted angle is typically in a range of 10° to 30° with respect to the ceiling grid plane 1012. In this embodiment LED light source 1007 mounted on a printed circuit board 1006 and optical element 1008 are configured to project a portion of the optical element light distribution 1030 away from the central non-optical cavity and partially onto a surrounding ceiling panel 1017. Depending on specific configuration, other portions of the optical element light distribution are projected directly downward into the room space below and/or reflected off of the linear support element 1002 or T-Bar bottom surfaces.

FIG. 10E details an embodiment direct lit linear lighting module 1001 configured for use in ceiling grid lighting assembly 1000A and 1000B. The lighting module is further configured for a uniform appearance and beam control and comprises linear support element 1002 configured to support and align LED light sources 1007 are mounted on a printed circuit Board 1006 which is fitted into the elongate housing 1003A with the aid of internal support features such as positioning tabs 1005 which create slots within which to position and retain the LED board. Other components supported and retained in position include a reflector 1011, a first lens 1013, and a second lens 1015. In this embodiment, positioning tabs support and retain all components in positions of optical alignment with the LED Light sources to provide optimal configuration for light distribution and appearance uniformity. The reflector 1009 functions to efficiently direct light out of the housing. The first lens 1013 and second lens 1015 can each be configured to contain bulk and/or surface features to provide one or more functions of diffusing, collimating, or redirecting light. Fresnel lenses are particularly useful in collimating and/or tilting beam patterns. Other embodiments may have more or fewer lenses (including no lenses) though which light is transmitted. In applications where a support element is mounted under the ceiling plane and projects onto a surrounding ceiling panel a light distribution commonly known as “wall grazing” or “wall washing” can be re-purposed with the ceiling instead of a wall as the illumination target area. This is represented by the ceiling grazing light distribution polar plot 1030 wherein the darker lobe on the polar plot is representative of the axis aligned with the cross-sectional plane and the lighter shading is representative of an axis aligned longitudinally with linear support element.

The embodiment in FIG. 10F further illustrates how the linear lighting module 1001 and linear support element 1002 can be housed in two separate elongate housings. In this embodiment the linear lighting module is contained in elongate housing 1003A and configured as a cartridge supported inside a second elongate housing 1003B which is effectively the linear support element 1002. In this embodiment the second elongate housing is used to retain the removable linear lighting module and connect or fix it to a T-Bar element. In these embodiments, the linear support element 1002 contain internal features 1005 which can be used to help retain the linear lighting module once it is in place.

FIG. 10G is a perspective cross-section view of an embodiment of linear lighting module 1001 comprising linear support element 1002 with an integrated optical assembly. The linear support element 1002 has an elongate body mounting portion 1017 for mounting over the vertical portion of a T-Bar, a positioning slot 1019 for mounting onto a horizontal portion of a T-Bar, and an angled support portion 1023 for supporting an assembly ceiling panel 1014 at an inclined angle. The elongate housing serves as both a structural member and also has positioning tabs for mounting optical components within the linear support element. These include a LED light source 1007, a printed circuit board 1006, a reflector 1009, a first lens 1011, and a second lens 1015 with both linear micro-structured features on its outer face and internal bulk diffusion properties which serves to further control the light distributions. The elongate housing also has an outer wall 1021 which be configured to serve as a reflective surface or as a decorative surface. In this embodiment the lower panel support tab 1018 is angled so as to support the ceiling panel at an angle that is tilted up from its edge and relative to the ceiling plane. The linear support element 1002 further supports a reflector 1018 behind the edgelit optical element and an optically transmissive component 1015 proximate to its outer face which in turn acts as the outer face of the linear lighting module 1001. In this type of configuration, a light source 1007 could be positioned on either or both edges of the edgelit diffuser and controlled independently to produce differing light distributions.

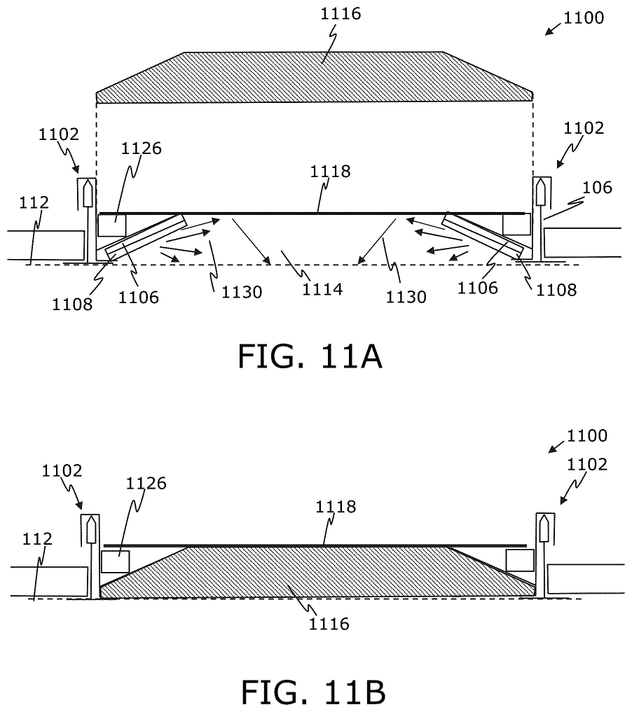

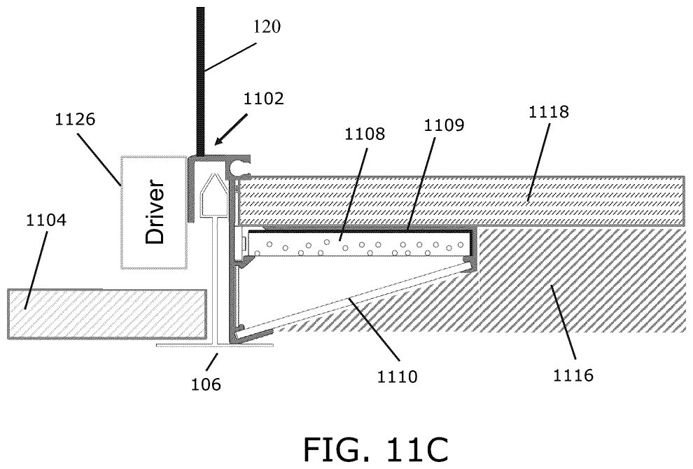

FIGS. 11A-11B are cross section views illustrating variations of ceiling grid lighting assembly embodiment 1100 within a suspended ceiling grid system with and without covering element 1116 in assembled position to provide an enclosing face of the optical cavity 1114. In embodiment 1100, the reflector 1118 is supported horizontally above the elongate body of the linear support element 1102. Furthermore, a printed circuit board 1106 (with light source) and optical element 1108 are oriented at an angle with respect to the ceiling grid plane 112. The inclined orientation tilts the optical element light distribution 1130 and also provides a different aesthetic appearance. As illustrated, a portion of the light from the light source illuminates the underside of the reflector 1118 and a portion is directed below the ceiling grid plane 112 into the room below. Some of the optical element light distribution 1130 is circulated within the central optical cavity 1114, for example, reflecting off of the reflector 1118 and/or the covering element 1116. Another portion of the optical element light distribution 1130 is projected directly from the optical assembly 1100. A driver 1126 is positioned and obscured from view by the linear support element 1102 as well as the light source 1106 and optical element 1108.

FIG. 11C provides specific details of an embodiment linear lighting module and its integral linear support element. A printed circuit board 1106 (with light source) inputs light into the edge of an edgelit diffuser 1108 and light is subsequently propagated through a second lens 1115 which is positioned at an inclined angle with respect to the ceiling grid plane 112 and the edge lit diffuser 1108 which are approximately parallel to each other. The edgelit diffuser of FIG. 11C is a rectangular shape but an alternate embodiment is a wedge shape. A reflector 1109 is positioned behind the edgelit diffuser to help improve efficiency and uniformity of the light output. Additionally, a portion of the reflector further wraps around a corner of the edgelit diffuser to provide a reflective surface on the edgelit diffuser face that opposes the input face. In this embodiment an LED driver 1126 is further supported by the linear support element 1102 on the opposing side of the T-bar. The linear support element 1102 is further attached the structural ceiling by a suspension cable 120.

Other components supported and retained in position by the linear support element 1102 include a reflector 1118, a first lens 1113 is designed to help smooth out the pixelation of the LED light source 1106, In this embodiment, positioning tabs support and retain all components in positions of optical alignment with the LED Light sources to provide optimal configuration for light distribution and appearance uniformity. The reflector 1118 functions to efficiently direct light out of the housing. plot is representative of the axis aligned with the cross-sectional plane and the lighter shading is representative of an axis aligned longitudinally with linear support element. The elongate housing serves as both a structural member and also has positioning tabs for mounting optical components within the linear support element. These include a LED light source 1107, a printed circuit board 1106, a reflector 1118, a first lens 1111, and a second lens 1115 with both linear micro-structured features on its outer face and internal bulk diffusion properties which serves to further control the light distributions.

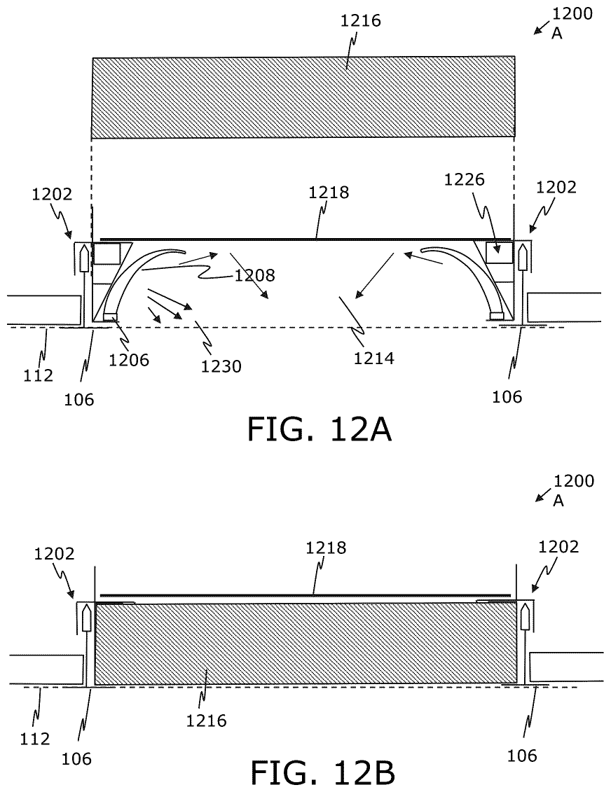

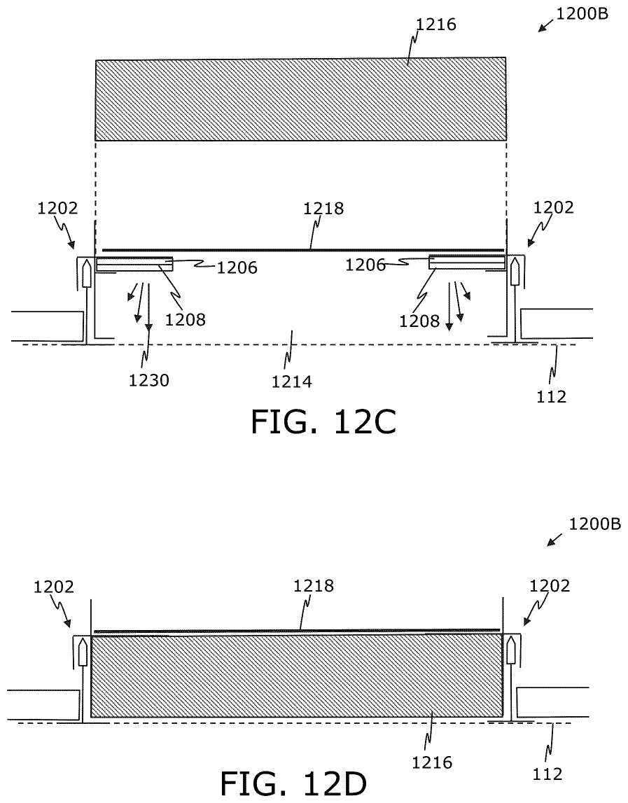

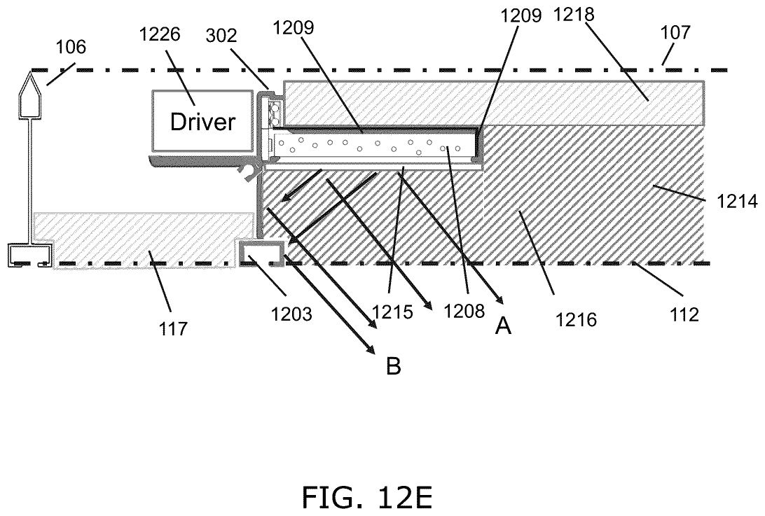

FIGS. 12A and 12B are cross-section views of ceiling grid lighting assembly embodiment 1200A with and without covering element 1216 in assembled position to provide an enclosing face of the optical cavity 1214 that is additionally bounded by the assembly ceiling panel 1218 that is supported by the linear support element 1202 at a height above the height of the T-Bar 106. As illustrated, a portion of the light from the light source illuminates the underside of the assembly ceiling panel 1218 and a portion is directed below the ceiling grid plane 112 into the room below. The edgelit optical element of FIG. 12A is an extruded arcuate shaped edgelit light guide 1208 that is positioned proximate to a printed circuit board 1206 (with light source). The light guide is essentially a curved wedge shape version of light guides used in other embodiments. This optical element 1208 can also be configured to provide light distribution control, brightness uniformity, and aesthetic interest benefits and typically has a reflector positioned proximate to its internal face and a secondary optical element can also be used such as a diffuser or light shaping lens to help further improved uniformity of light and its distribution.

FIG. 12C and FIG. 12D are cross section views of ceiling grid lighting assembly embodiment 1200B with and without the covering element 1216 in assembled position to enclose the central optical cavity 1214. FIG. 12C illustrates details of variations in embodiment linear support element wherein light from a horizontally mounted edgelit low clarity diffuser 1208 propagates through a second lens 1215 and into the optical cavity 1214. In FIG. 12C the edgelit diffuser 1208 is positioned below the assembly ceiling panel 1218.

FIG. 12E illustrates a cross-section view of a linear lighting module 1201 implemented in the ceiling grid lighting assembly embodiment 1200A or 1200B with the covering element or end plate 1216 in assembled position to provide an enclosing face of the optical cavity 1214 that is additionally bounded by the reflector 1218 that is supported by the linear support element 302 at a height above the height of the T-Bar 106. As shown, the linear lighting module 1201 comprises a 9/16″ slot style T-bar feature 1203. As illustrated, a portion of the light from the light source illuminates the underside of the reflector 1218 and a portion is directed below the ceiling grid plane 112 into the room below. The edgelit optical element of FIG. 12A is an extruded arcuate shaped edgelit light guide 1208 that is positioned proximate to the PCB 1206 with light source). The light guide is essentially a curved wedge shape version of light guides used in other embodiments. The optical element 1208 can also be configured to provide light distribution control, brightness uniformity, and aesthetic interest benefits and typically has a reflector 1218 positioned proximate to its internal face and a secondary optical element can also be used such as a diffuser or light shaping lens to help further improved uniformity of light and its distribution. Further shown, the linear support element 302 supports an LED board in a vertical position and is horizontally supported edgelit optical element 1208 and a horizontally supported output face 1215 wherein a reflector 1218 is supported above the ceiling grid plane 112 and horizontally and above both. The embodiment 1201 is also configured so as to be positioned in the ceiling grid between two T-bars and aligned perpendicularly to a mounting T-bar at either of its longitudinal ends and supported from its longitudinal ends either by resting on the mounting T-bar or by a supporting end plate. In this configuration the linear support element 302 is not mounted on a T-bar along its longitudinal length but rather is perpendicular to the mounting T-bar and can functionally replace a T-bar when used in a ceiling grid assembly 1200A or 1200B. In this embodiment the sides of the linear support element become an important internal surface of the optical cavity 1214 and is connected to the covering element or end plate 1216 as illustrated by optical ray B. Light is reflected back by a reflective surface 1209 on the opposing face of the edgelit optical element 1208 and is reflected from the side of the linear support element 302. Other embodiments may configure this reflective surface 1209 with features or surface finishes to further customize the appearance and function of the reflective surface 1209.

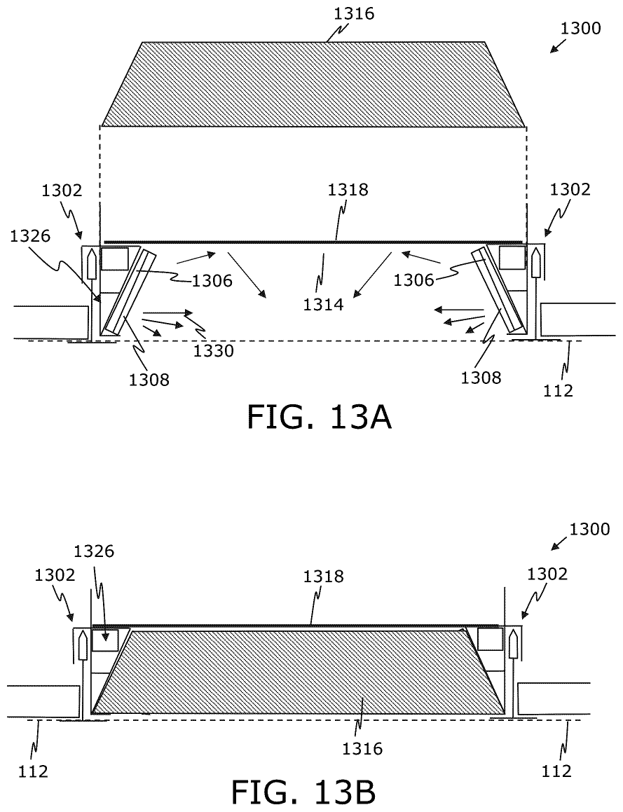

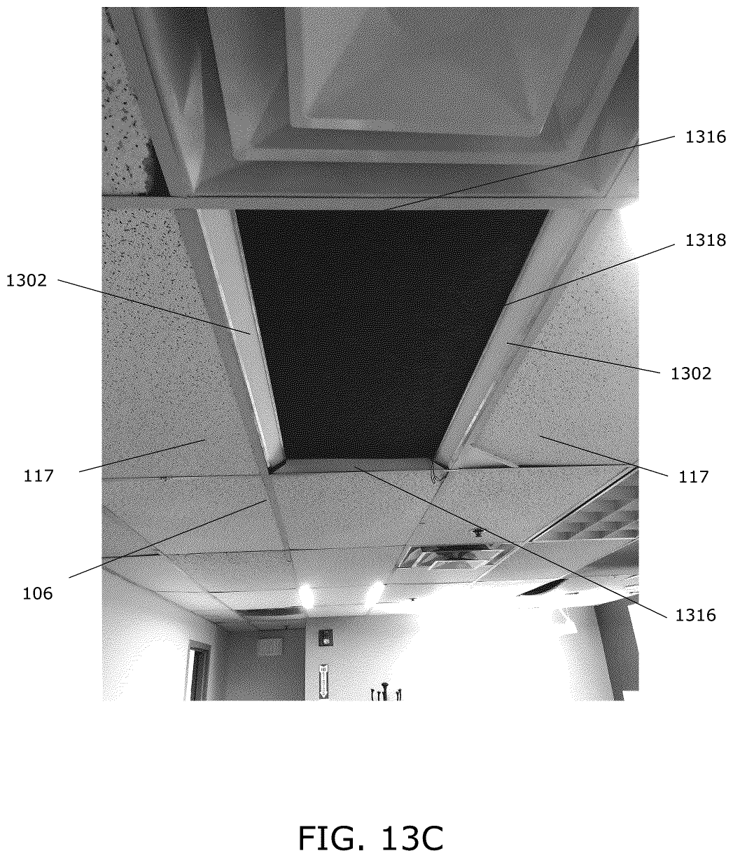

FIGS. 13A and 13B are views illustrating variations of ceiling grid lighting assembly embodiment type 1300 within a suspended ceiling grid system which contains linear support element 1302 supports the ceiling panel horizontally 1316 at an elevated height relative to the ceiling grid plane 1312 and is further comprising an optical element 1308 which is angled or tilted with respect to the ceiling grid plane 112. FIG. 13A and FIG. 13B are cross section views with and without the covering element 1316 in assembled position to enclose the central optical cavity 1314. As illustrated, a portion of the light from the light source illuminates the underside of the assembly ceiling panel 1318 and a portion is directed below the ceiling grid plane 112 into the room below.

FIG. 13C shows a below ceiling grid perspective view of the embodiment 1300 when applied to a 2 ft×4 ft ceiling grid cell. In the embodiment the assembly ceiling panel is comprised of coloured acoustic felt. Light is reflected back by the reflector 1318 on the opposing face of the edgelit optical element and is reflected from the side of the linear support element 1302. Other embodiments may configure this reflective surface with features or surface finishes to further customize the appearance and function of the reflective surface.

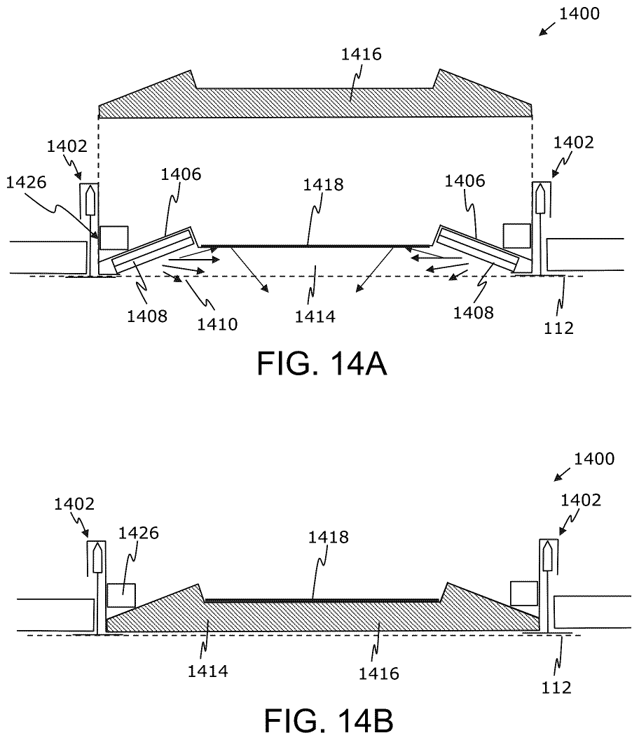

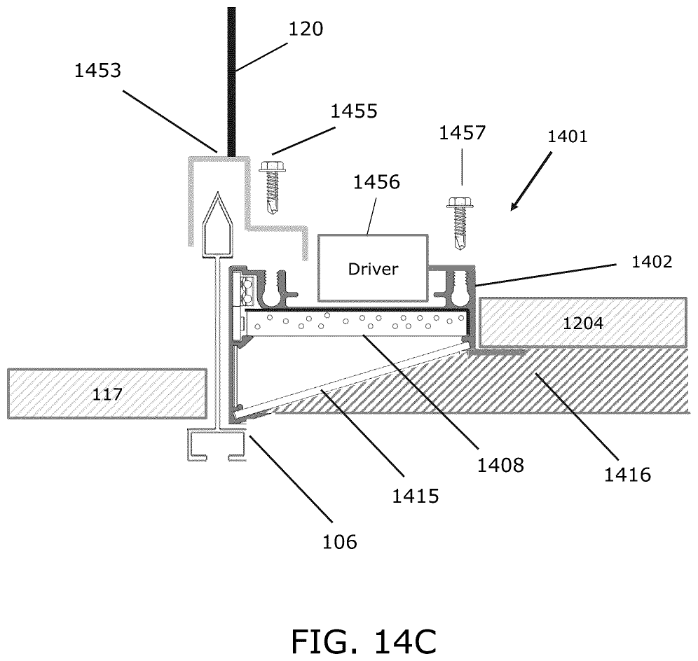

FIGS. 14A-14B are views illustrating variations of ceiling grid lighting assembly embodiment type 1400 within a suspended ceiling grid system wherein an assembly ceiling panel 1418 is smaller in width than the T-Bar grid spacing and supported by two opposing linear support elements 1402 which each also hold in inclined position printed circuit board 1406 (with light source) and optical element 1408. As illustrated, a portion of the light from the light source illuminates the underside of the reflector 1418 and a portion is directed below the ceiling grid plane 112 into the room below. FIG. 14A and FIG. 14B show respectively views with and without the covering element 1416 in assembled position as an enclosing face of the central optical cavity 1414.

FIG. 14C illustrates detail of embodiment linear lighting module 1401 comprising support element 1402 configured to mount onto a T-Bar wherein the light source comprises an LED board with linear array of LEDs and the optical element 1408 is an edgelit diffuser mounted in a horizontal position. Furthermore, a second lens acting as the output surface of the module 1415, is positioned at an inclined angle in order to adjust the light distribution output and/or increase brightness uniformity. FIG. 14C also illustrates an embodiment configured to mount on a T-Bar with the covering element 1416 and linear support element 1402C further comprising a mounting bracket 1453 which is fastened in position with screws 1455 to mount onto the T-Bar 106. Furthermore, the driver 1426 can also be mounted to the linear support element by a bracket and screw.

Additionally, as shown in FIGS. 3-14, according to an embodiment, in the ceiling grid lighting assembly 300, 400, 500, 600, 700, 800, 900, 1000, 1100, 1200, 1300, 1400 the at least one linear support element 302, 402, 502, 602, 702, 802, 902, 1002, 1102, 1202, 1302, 1402 comprises a mounting portion that mounts over the vertical portion 108 (shown in FIG. 1) of a ceiling grid T-Bar 106. In the aforementioned embodiments the linear support element comprises the mounting portion that is mounted over the vertical portion 108 of the T-Bars 106 in operation. Optionally, the mounting portion is detachably mounted on the given T-Bar by accommodating a thickness of the flat vertical portion 108 of the T-Bars 106 between a recess or cavity (such as the central optical cavity 122) having an elongate U-shaped structure. In an example, the mounting portion may be coupled using a coupling means such as screws, nuts, bolts, adhesives, rivets, tie-wraps, and the like. In another example, the mounting portion may be coupled using a sliding mechanism such as a slider, a roller, and the like. In such an example, the mounting portion may slide over the flat vertical portion 108 of the T-Bars 106 and provide an ease of detaching thereof. Additionally, the mounting portion includes a thickness, a length, and a height (less than the vertical portion 108 of the T-Bars 106. Optionally, the material for manufacturing the mounting portion may include metals, metal alloys, hardened polyvinyl materials, plastics materials, glass-filled plastics materials, ceramic materials, and the like. Furthermore, optionally, the mounting portion includes a plurality of flat supporting portions. The term “flat supporting portion” as used herein relates to solid structures molded to form the mounting portion of the linear support element. Furthermore, the mounting portion of the linear support element is integral and molded in a substantially U-shaped structure. It will be appreciated that the term “substantially U-shaped structure” herein relates to a shape resembling an alphabetical letter “U” and a structure having a vertical left elongate member, a vertical right elongate member, and a curved member (or alternatively, a horizontal member) adjoining as integral to the lower end of the vertical left elongate member and the vertical right elongate member. In an example, each of the flat mounting portions are mutually separate and may be coupled to the curved member by coupling means or arrangements, such as welding, adhesives, fasteners, and the like.

In yet another aspect, the present disclosure also provides a lighting assembly 1500 supported within a ceiling grid system. It will be appreciated that the elements of the lighting assembly 1500 may or may not be similar to the lighting assembly 100 depending upon the need of the implementation.

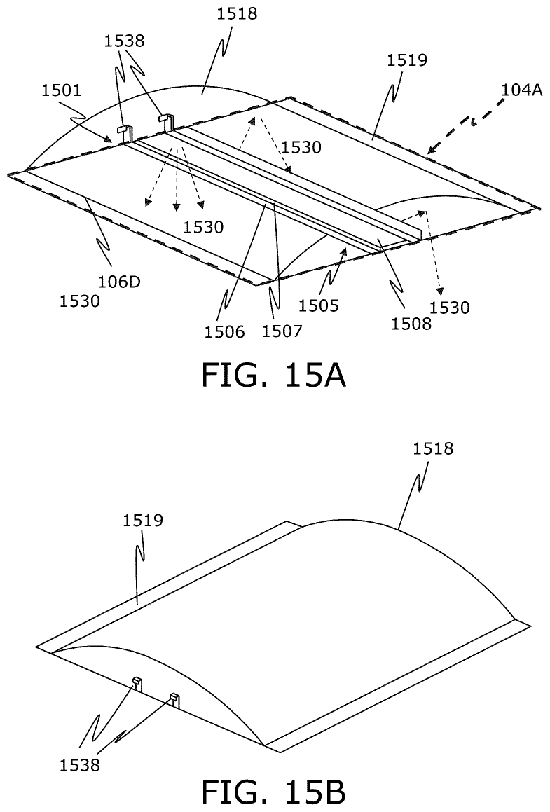

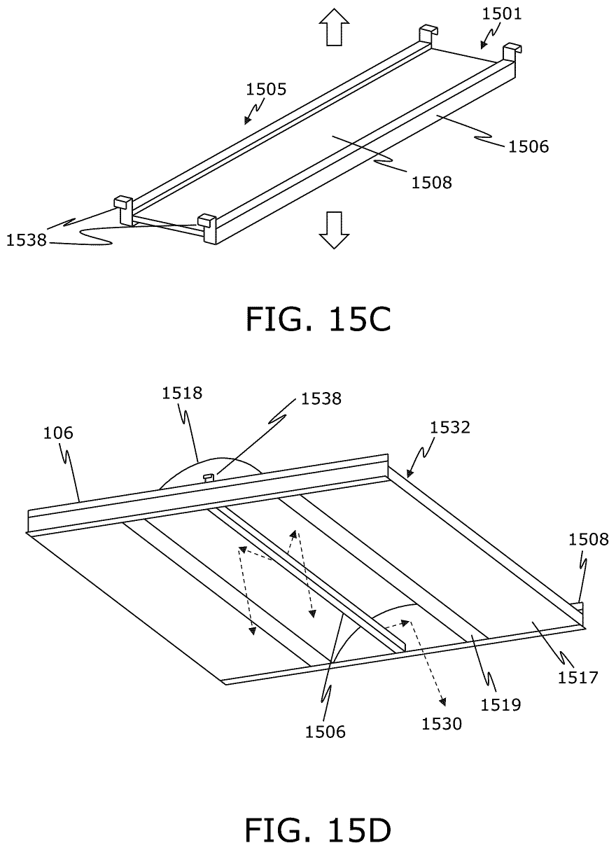

Referring to FIGS. 15A to 15B, illustrated are bottom and top perspective views of the lighting assembly 1500 supported within a ceiling grid system, wherein the ceiling grid system comprises an array of T-bar cells 104 having ceiling grid T-bars 106 with vertical 108 and horizontal portions 110, wherein a plane containing the horizontal portions 110 of the ceiling grid T-bars 106 defines a ceiling grid plane 112. The lighting assembly 1500 comprises a T-bar cell 104A within the T-bar grid array 104 that provides structural integrity to the lighting assembly 1500.

The lighting assembly 1500 further comprises at least one linear lighting module 1501 arranged within the T-bar cell 104A and supported on vertical portions 108 of a pair of laterally (mounting) spaced apart T-bars 106A, 106C of the T-bar cell 104A. Herein, the lighting assembly 1500 may have any number of linear lighting modules 1501 arranged in various positions and/or arrangements to beneficially have a vivid variety of aesthetically pleasing lighting distribution 1530. In another example, there may be two linear lighting modules 1501A and 1501B. that may be spaced apart by a predefined distance to provide a modular appearance, wherein the linear light modules 1501A and 1501B may be arranged parallel to each other or inclined to each other at a predefined angle.

Further, as shown in FIGS. 15A and 15B, the at least one linear lighting module 1501 comprises an optical assembly 1505 having at least one LED light source 1506 and at least one printed circuit board 1507 and a reflector 1518 configured to be arranged on the horizontal portions 110 of at least a pair of laterally spaced apart T-bars 106B, 106D of the T-bar cell 104A, wherein the reflector 1518 is configured to form a central optical cavity 1514 that spans at least partially or completely over the T-bar cell 104A and above the ceiling grid plane 112, and wherein the reflector 1518 and the at least one linear lighting module 1501 are configured to illuminate a space (i.e., the central optical cavity 1514) or a surface (such as, the floor, the ceiling, or any other surface) above or below the ceiling grid plane 112 at least directly or indirectly. Typically, the at least one linear lighting module 1501 may be a multi-directional lighting module emanating light distribution in multiple directions such as, above, below or on the sides. Thus, the linear lighting module 1501 may be arranged on the horizontal portions 110 of at least a pair of laterally spaced apart T-bars 106B, 106D of the T-bar cell 104A to provide the light distribution 1530 either directly or indirectly upon reflection from surrounding surfaces (such as, the surface of the reflector 1518) into the central optical cavity 1514, wherein the light distribution 1530 is reflected back by the reflector 1518 towards the ceiling grid plane and exiting there below to illuminate the entirety of the room. Moreover, the linear lighting module 1501 is also configured to provide the light distribution 1530 directly below the ceiling grid plane 112 i.e., to sufficiently illuminate the room or space in which the lighting assembly 1500 is situated. Beneficially, such an arrangement of the linear lighting module provides an improved light distribution 1530 having increased intensity and also provides a visually appealing three-dimensional appearance look to the attributed by the reflective properties and the shape of the reflector 1518 that enables the linear lighting module 1501 to effectively illuminate the entire space or room either directly or indirectly.

In one or more embodiments, the reflector 1518 comprises at least a pair of support flanges 1519 configured at a pair of laterally opposite edges of the reflector 1518. Typically, the reflector 1518 may comprises at least the pair of support flanges 1519 configured on a pair of laterally opposite edges of the reflector 1518 to further accommodate or provide support to surrounding ceiling panels 1517. Optionally, the support flanges 1519 may be used to support or accommodate other electronic or mechanical elements (such as, the electric driver 126) of the lighting assembly 1500 therein. Optionally, the support flanges 1519 may extend to another reflector 1518A in case of more than one reflector to provide different appearance of the lighting assembly and thereby different light distributions 1530 therefrom.

Referring to FIG. 15C, illustrated is an exemplary linear lighting module 1501 implemented in the lighting assembly 1500, in accordance with an embodiment of the present disclosure. As shown, in one or more embodiments, each of the at least one linear lighting module 1501 comprises a pair of hooks 1538 configured to be supported on the vertical portions 108 of the pair of laterally spaced apart T-bars 106A, 106C of the T-bar cell 104A. Typically, the hooks may be made of a suitably hard material to increase the rigidity of the linear lighting module 1501. For example, the hooks 1538 may be made of a metal, a polymer, a plastic. Herein, the hooks 1538 are shaped to accommodate the reflector 1518 in a fixed position such that the light distribution 1530 is not disturbed due to a positional change of the reflector 1518. Beneficially, the hooks 1538 increase the structural integrity of the linear lighting module 1501 and may also be employed with other elements such as ceiling panels 1517 without any change.

In one or more embodiments, the optical assembly 1505 further comprises at least one optical element 1508. In some embodiments of the linear lighting module 1501 or the optical assembly 1505 therein, the optical assembly 1505 further comprises the at least one optical element to improve and uniformize the light distribution 1530. In comparison to earlier embodiments, the linear lighting module 1501 may or may not include the optical element therein depending upon the need of the implementation.

Referring to FIG. 15D, illustrated is a bottom perspective view of lighting assembly 1501, in accordance with one or more embodiments of the present disclosure. As shown, the lighting assembly 1500 further comprises a pair of linear lighting modules 1501A, 1501B laterally spaced apart with an optical element 1508 arranged between the pair of linear lighting modules 1501A, 1501B. Herein, the space between the pair of linear lighting modules 1501A, 1501B may be varied to provide different types of light distributions 1530. In one or more embodiments, the light assembly 1500 further comprises at least one ceiling panel 1517 configured to cover a gap 1532 of the T-bar cell 104A when the reflector 1518 partially spans over the T-bar cell 104A. In cases wherein the lighting assembly 1500 further comprises a pair of linear lighting modules 1501A, 1501B laterally spaced apart with an optical element 1508, there may be a gap 1532 left in the T-bar cell (as viewed from the bottom), that may be covered by the at least one ceiling panel 1517 to provide a finished and aesthetic appearance to the lighting assembly 1500. Optionally, the reflector 1518 by virtue of the support flanges 1519 may extend towards the opposite edges of the T-bar cell 104A to completely cover the gap 1532.

In one or more embodiments, the at least one linear lighting module 1501 is arranged centrally or non-centrally with respect to the central optical cavity 1514. Typically, the at least one linear lighting module 1501 may be placed either centrally to bisect the T-bar cell, or non-centrally to potentially add or accommodate more than one lighting module 1501 to provide sufficient lighting throughout the room based on the needs of the implementation.

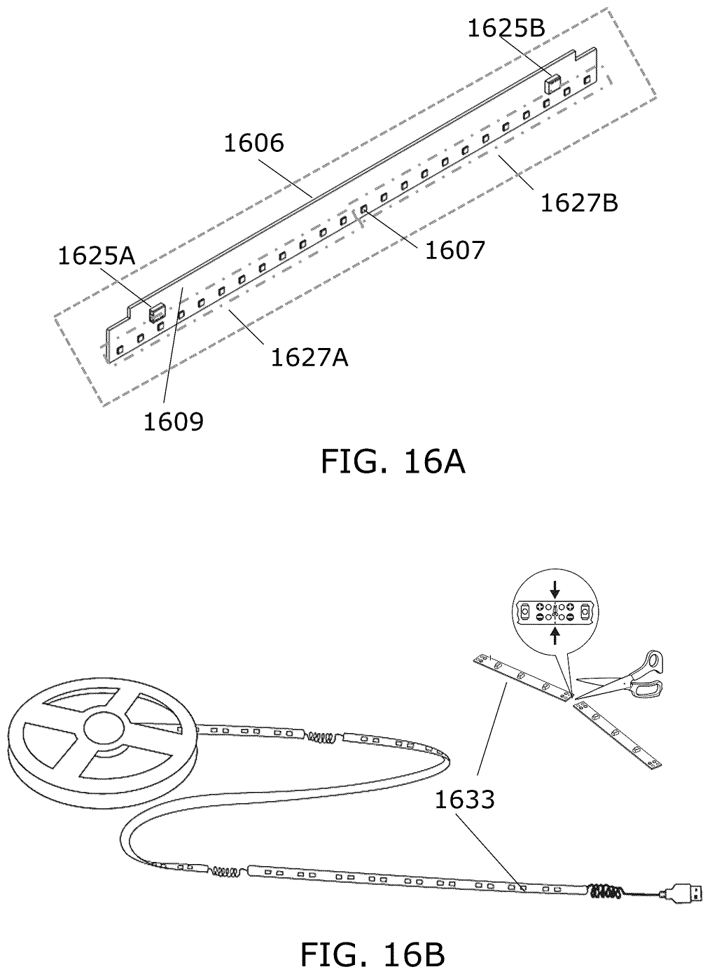

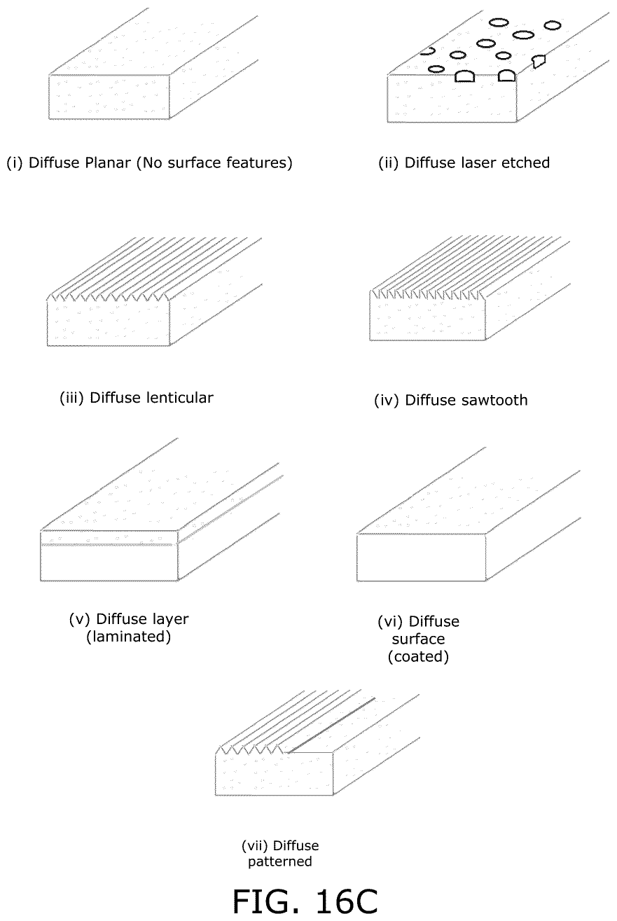

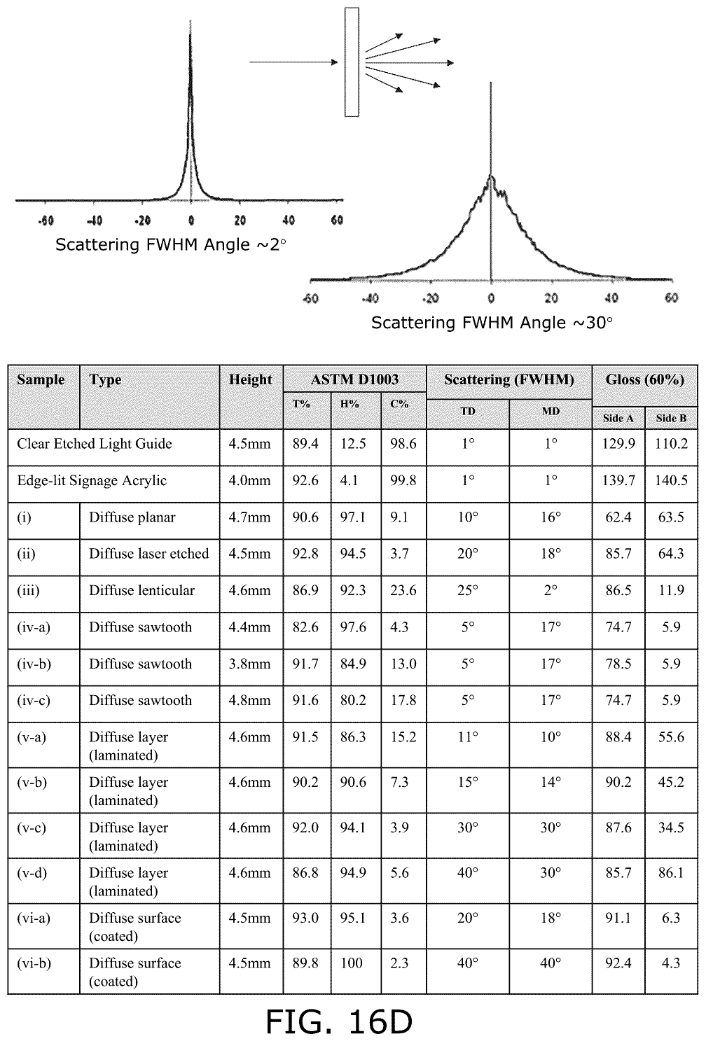

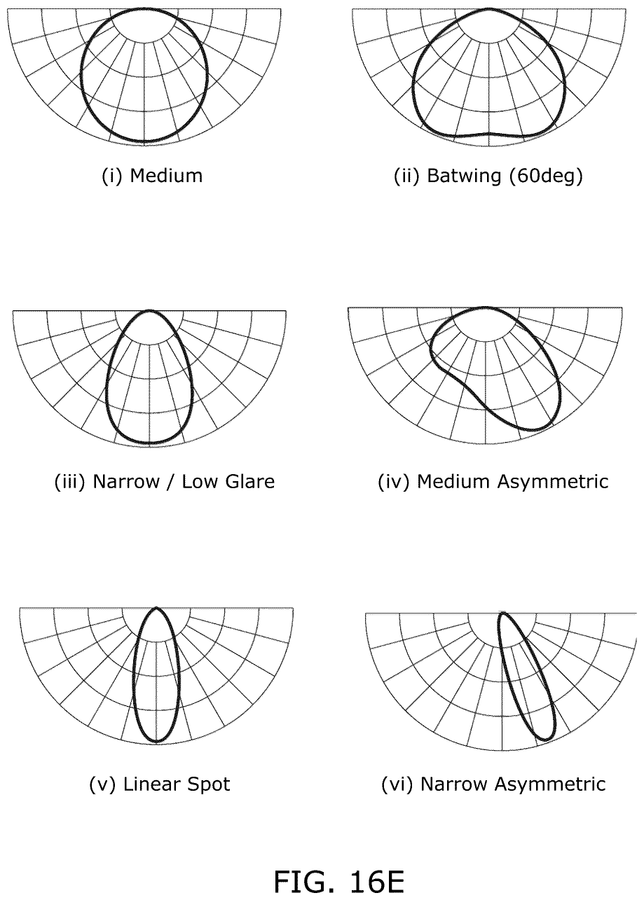

FIG. 16A and FIG. 16B are embodiment configurable linear LED boards; FIG. 16A showing an embodiment with rigid linear printed circuit board (PCB) 1606 with packaged LED light sources 1607 mounted on the PCB and connected via its electrical circuit. The configurable linear LED light source 1633 of FIG. 16A shows a version with two individual electrical channels 1627A and 1627B each one having a separate electrical connector 1625A and 1625B which allow the string of 12 LEDs connected in series 1609 in each electrical channel to be electrically addressed and controlled. In the embodiment shown the LEDs 1607 are arranged into two parallel connected circuits of 12 LEDs in series. The forward voltage is approximately 33V although this is typically modified to match the requirements of the driver or controller being used. The rigid PCB board 1606 can also be cut to length at increments between each electrical channel. FIG. 16B illustrates a flexible strip which can be cut to length off of a reel. As shown in FIG. 16B, configurable linear LED light sources 1633 can also be manufactured on a flexible circuit material and supplied in a “tape-like” format on a reel with multiple segments corresponding to a maximum required length and then cut to length as needed for various versions of linear support elements.

FIG. 16C isometric illustrations of various embodiments of edgelit optical elements used in ceiling grid lighting assemblies illustrating key elements. Important to various embodiments are dimensions of width and height. Volumetric light diffusion is produced by dispersed regions within the light guide having refractive index different than the bulk matrix material. Concentration of diffusing blend is an important variable in effecting light scattering properties that influence angular light distribution and uniformity of beam pattern. Embodiments described include in the light guide formulation a specific commercially available diffusion resin, Plexiglas® Diffuse V045 blended into clear PMMA resin at the indicated weight percent within a range from zero to 20%. Alternative means in creating dispersed regions of differing refractive index from the light guide matrix material include dosing microbeads into the light guide resin formulation as well as forming second phase regions in situ during by fluid phase mixing of immiscible blends of polymers. In addition to refractive index, the quantity per volume, size, and shape of dispersed regions effect light scattering properties. In the case of immiscible blends formed by fluid phase mixing, the shape of second phase regions may be other that spherical, for example oblate paraboloid, thereby generating non-symmetric light scattering. Processes for fabricating light guides include extrusion and injection molding. Surface features and their pattern of arrangement on a face of the light guide are of importance in converting internal reflection within the light guide to output from the module at desired angular light distribution.

FIG. 16D is table containing optical properties of various embodiments of edgelit optical elements. Ceiling grid lighting assemblies were configured using both high clarity light guides and low clarity edgelit diffusers.

FIG. 16E illustrates the range of lighting distributions that can be achieved by configuring the linear lighting module. A wide range of non-lambertian, anisotropic lighting distributions are provided based upon various direct lit and edgelit optical elements and a secondary outer lens with varying degrees of volumetric light scattering and surface microstructures such as prisms, microlens and sawtooth lenticular features. Lighting distributions are possible that are anisotropic or non-lambertian and lighting distributions can also be tilted or asymmetric which is particularly important for wall washing, task lighting or cove lighting. In general, overall light distribution of a ceiling grid lighting assembly correlates with the light distribution of individual light sources, optical elements, and ceiling panels within the ceiling grid lighting assembly and particular components and their arrangement can be selected to create specific desired light distributions. Additional lighting distributions can also be achieved by changing the configuration of the edgelit optical element, e.g. light guide or edgelit diffuser, or the amount of light input into an optical element. For example, two independent electrically addressable LED light sources can be positioned to input light into two edges of a single optical element and electrical power can be applied to each channel independently to adjust light distribution. Polar plot illustrations 16Eii, 16Eiv, and 16Evi Examples of non-lambertion light fixture outputs are shown in FIG. 16Eii (batwing), FIG. 16iii (narrow/low glare), FIG. 16Eiv (medium asymmetric), FIG. 16Ev (linear spot) and FIG. 16vi (Narrow Asymmetric).

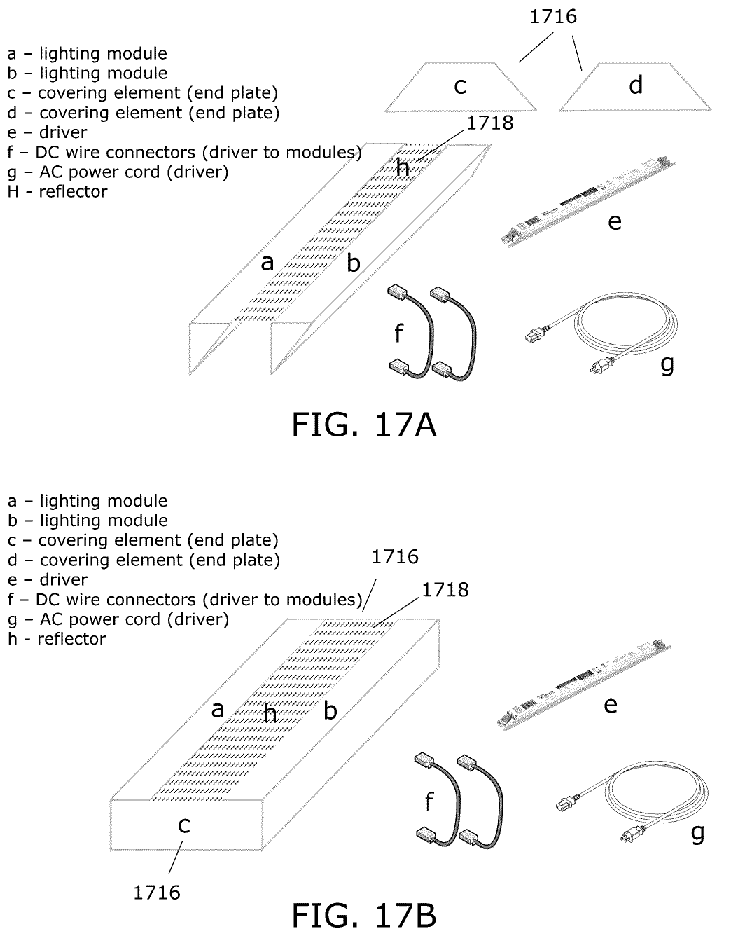

FIG. 17A is an illustration of individual components for use in configuring and installing embodiment modular ceiling grid lighting assemblies in combination with a ceiling grid system. A benefit of the ceiling grid lighting assembly as detailed in the embodiments is that it can be shipped as a kit of parts and “flat packed” which can significantly save on volume and weight. This in turn can reduce carbon footprint. The parts can also be designed to easily connect together at the job site prior to install. Linear support elements can be preassembled with integrated optical assemblies prior to shipment, and other components including the covering elements 1716 can be selected for retrofit into an existing ceiling grid system or for concurrent assembly into a new installation.

FIG. 17B is an illustration of partially pre-assembled components for use in configuring and installing embodiment ceiling grid lighting assemblies in combination with an existing ceiling grid system or in the case of a new installation, suspended ceiling grid components. In this illustration the ceiling grid lighting assembly can be shipped as a partial assembly of the linear support element (a & b) and covering elements (c & d) 1716 and the reflector (h) 1718 securely connected to each other assembled. The remaining driver 1726, wire connectors and power cord are packed and shipped individually.

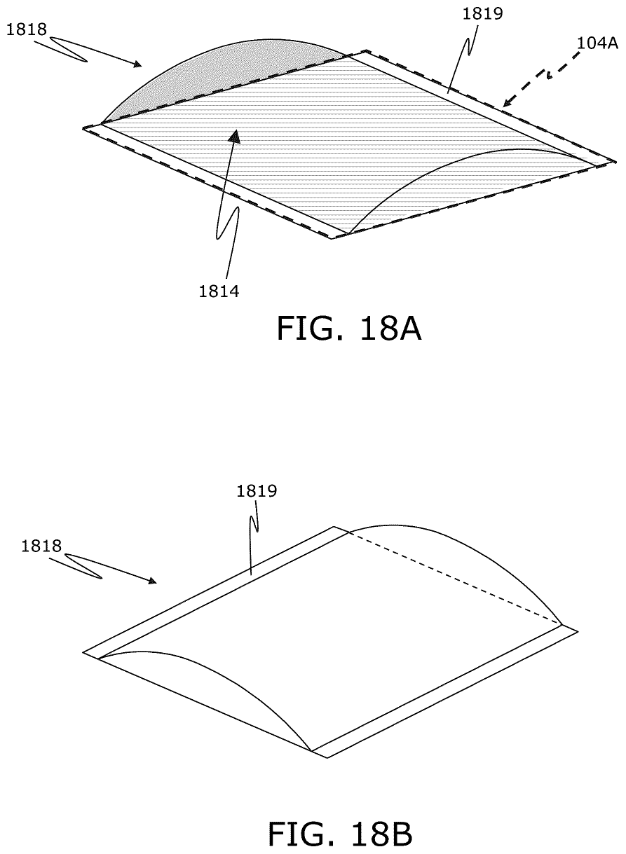

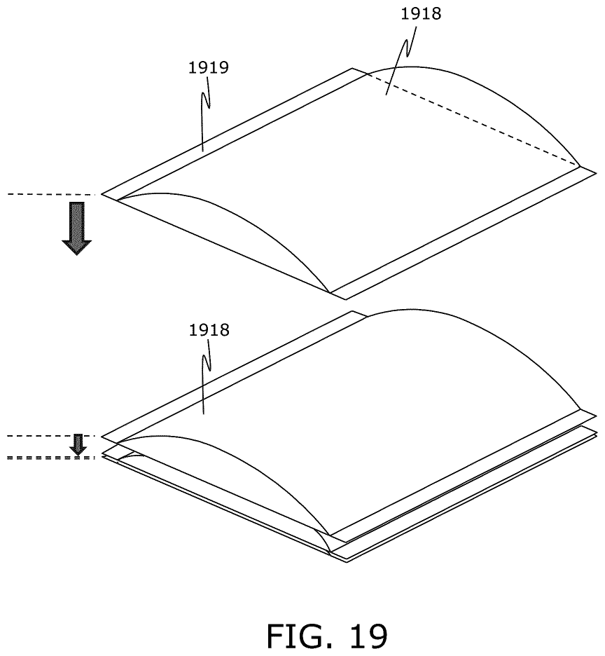

FIG. 18A (below ceiling plane view) and FIG. 18B (above ceiling plane view) are isometric views of an embodiment lighting assembly reflector 1818 which is formed with an internal optical cavity 1814 and a supporting flange 1819 to enable the reflector to be positioned upon a T-bar horizontal portion at the perimeter of a T-bar cell 104A.

FIG. 19 is a view of a stacking process for transport and/or storage of multiple embodiment lighting assembly reflector component embodiments of FIG. 18. A large number of reflectors can be sequentially stacked to minimize the amount of volume required in transport and/or storage of assembled light fixtures. For example, stacks of reflector components could be stored on shelf or shipping pallet, or in a box. In addition to saving volume, the weight of a reflector can be minimized by a low density material and thin wall thickness; for example by use of a thermoformed polymer film or sheet. In combination with other pre-assembled components such as illustrated in FIG. 17A, a complete kit of components for a ceiling grid lighting component, minus the ceiling grid, can be efficiently packaged, stored, and shipped for assembly at a ceiling grid assembly installation site. Components of the kit can be preselected for a specific layout of lighting assemblies within a ceiling grid assembly, or alternatively a mixture of components and sub-assemblies can be included to enable a more flexible process of layout design and adjustment at the site of installation. In an embodiments of a field configurable lighting assembly, the installation can take place in tandem with the installation of a ceiling grid system. Alternatively, installation can take place within a pre-existing ceiling grid system, either as part of a sequenced installation process or as part of a retrofit project.

Embodiment lighting modules and lighting assemblies provide advantages in configuring lighting fixtures within ceiling grid arrangements to meet seismic design considerations; for example, as defined by the International Building Code Seismic Design Categories D, E & F. In particular embodiments of modular ceiling grid lighting assemblies may be configured for advantage in seismic design compliance by reducing light fixture weight, providing alternative grid attachment, and allowing improved plenum accessibility thereby specifically 1) providing means of positive attachment to the ceiling grid, 2) eliminating the need for supplemental hanging wire since an integrated linear support element could replace a cross runner and support at least 10 lbs, 3) allowing for easier, quicker and cheaper slack wire attachment for lighter weight categories, 4) avoiding the need of “approved hangers” for fixtures weighing over 56 lbs, and 5) providing a safe and flexible electrical “conduit” system within the overall ceiling grid assembly.

Embodiments of the present disclosure provide a lighting assembly within a ceiling grid system. In another aspect, the present disclosure also provides a ceiling grid system comprising T-Bar cells defined by the vertical and horizontal portions of the T-Bars. The ceiling grid system comprises at least one supporting element, wherein the ceiling grid system may be formed by supporting a plurality of ceiling panels thereon the at least one supporting element. Such supporting of the plurality of ceiling panels on the at least one supporting element enables convenient installation and replacement of the ceiling grid system, such as, by arranging the at least one supporting element on the T-Bars and arranging the plurality of ceiling panels on the at least one supporting element. Furthermore, when one or more of the at least one supporting element are determined to have a defect therein, the defective supporting element can be easily replaced without having to replace an entirety of the ceiling grid system. Furthermore, the at least one supporting element may be easily fabricated in a cost-effective manner to have different properties (such as, orientations of linear and/or ceiling panel supporting portions) relative to each other, thereby, enabling to provide different appearances and easy customizability to the ceiling grid system. The supporting elements can be used to support the plurality of ceiling panels, as well as other components, such as utility components including electrically and/or electronically operated devices such as sensors, at least one optical element such as light guides and so forth. Such utility components and the at least one optical element can be used to provide additional functionality to the ceiling grid system (such as, using a plurality of sensors, smoke detectors and so forth for increasing a safety in an enclosure wherein the ceiling grid system is installed), and/or for improving an aesthetic appearance associated with the ceiling grid system (such as, by using at least one light source, multichromatic light sources and so forth), respectively. Furthermore, the ceiling grid system includes the at least one supporting element mounted on T-Bars to support the plurality of ceiling panels. Such supporting elements can be mounted on existing T-Bars associated with conventional ceiling grid systems, thereby, enabling easy, time-efficient, and cost-efficient replacement of a conventional ceiling grid system with a ceiling grid system of the present disclosure. For example, when the conventional ceiling grid system comprises troffer fixtures therein, the at least one supporting element can be installed on the conventional ceiling grid system, such as in a 2×4, 2×2 or 1×4 configuration. For example, two supporting elements with an integrated optical assembly can be installed on either side of the troffer fixture and two supporting elements can be installed on either end of the troffer fixture, with a ceiling panel arranged on one or more of the at least one supporting element. Alternatively, a covering element can be arranged on the at least one supporting element instead of the at least one ceiling panel without limiting the scope of the disclosure. Beneficially, the present disclosure provides a ceiling grid system to improvise maintenance of the appearance of ceiling panels. Specifically, the at least one supporting element is mounted on the T-Bars of the ceiling grid arrangements to support the plurality of ceiling panels at different orientations such as in a plane parallel, above, below, and at a tilted angle to the horizontal portions of the T-Bars defining the ceiling grid plane. Additionally, the plurality of ceiling panels are arranged at different orientations to provide a three-dimensional appearance to the ceiling grid system. It will be appreciated that such a ceiling grid system having the three-dimensional appearance corresponds to an appealing appearance thereof. Furthermore, orientations of the at least one supporting element and/or ceiling panel can be easily changed, thereby, enabling convenient customization of the ceiling grid system.

The present disclosure provides an energy efficient and energy saving lighting assembly configured for enabling a reduced greenhouse gas emission from the lighting assembly by reducing the average energy consumption with respect to conventional lighting assemblies and reducing usage and implementation during times of minimal or no usage. Consequently, the ceiling grid lighting assembly can be remotely dimmable via a communication link (for example via the daisy-chain connection or via wireless control, or both) or can be controlled locally (for example by the lighting assembly having a motion sensor integrated therewith, a low-resolution charged-coupled device (CCD) camera or a photocell coupled to an image processing integrated circuit (IC) implemented as a microcontroller, a field-programmable gate array (FPGA) for motion detection, alternatively an ultrasonic motion detector).

Modifications to embodiments of the present disclosure described in the foregoing are possible without departing from the scope of the present disclosure as defined by the accompanying claims. Expressions such as “including”, “comprising”, “incorporating”, have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A field configurable lighting assembly that is supported within and assembled at a site of a ceiling grid system, wherein the ceiling grid system comprises an array of T-bar cells further comprising ceiling grid T-bars with vertical and horizontal portions, wherein a plane containing the horizontal portions of the ceiling grid T-bars defines a ceiling grid plane, the field configurable lighting assembly comprising;
a) at least one T-bar cell that provides structural integrity to the lighting assembly;
b) at least one linear lighting module comprising;
i) at least one optical assembly comprising at least one LED light source, at least one printed circuit board, and at least one optical element;
ii) at least one linear support element configured to be arranged onto a mounting T-bar within the at least one T-Bar cell, wherein the at least one linear support element comprises an elongate body configured to support and align components of the at least one optical assembly; and
c) at least one reflector or internal reflecting surface configured to be arranged on a combination of linear support elements and ceiling grid T-bars to form an optical cavity within a T-bar cell and above the ceiling grid plane, wherein the reflector partially or completely encloses the optical cavity.

2. The field configurable lighting assembly of claim 1 installed in tandem with the ceiling grid system.

3. The field configurable lighting assembly of claim 1 installed within a pre-existing ceiling grid system.

4. The field configurable lighting assembly of claim 1 wherein a kit of of reflectors and any combination of linear lighting modules, linear lighting module components, or linear lighting module sub-assemblies packaged are transported to the assembly site.

5. The field configurable lighting assembly of claim 1 wherein reflectors for assembly are transported or stored in a stacked configuration.

6. The field configurable lighting assembly of claim 1 wherein the optical cavity is a central optical cavity or a pair of optical cavities.

7. The field configurable lighting assembly of claim 6 wherein a pair of optical cavities are arranged either within a single T-bar cell or are divided between two T-bar cells.

8. The field configurable lighting assembly of claim 1, wherein the reflector is one of a standard ceiling panel, an acoustic ceiling panel, a decorative tile, a planar reflective panel or a non-planar reflective panel.

9. The field configurable lighting assembly of claim 1, wherein the reflector is configured to form the optical cavity having one of a partial or complete frustrum shape, a dome shape, a hemispherical shape, a conical shape, a cuboidal shape, a cubical shape, a trapezoidal shape and any combination thereof.

10. The field configurable lighting assembly of claim 1, wherein the reflector comprises at least one of a surface causing specular reflection and diffuse reflection.

11. The field configurable lighting assembly of claim 1, wherein the reflector is selected from the group consisting of a metallic mirror and a multilayer reflective mirror.

12. The field configurable lighting assembly of claim 1 wherein a reflector partially encloses the optical cavity and the field configurable lighting assembly further comprises at least one covering element coupled such as to provide an enclosing face of the optical cavity within the field configurable lighting assembly.

13. The field configurable lighting assembly of claim 12, wherein the at least one covering element further encloses at least one longitudinal end of a linear lighting module.

14. The field configurable lighting assembly of claim 12, wherein the at least one covering element is arranged at an angle not parallel with the ceiling grid plane.

15. The field configurable lighting assembly of claim 12, wherein the at least one covering element is attached to an additional T-bar of a T-bar cell that is on an adjacent side from the mounting T-bar.

16. The field configurable lighting assembly of claim 12, wherein the at least one covering element has a shape that is rectangular, triangular, arcuate, or any combination thereof.

17. The field configurable lighting assembly of claim 12, wherein the at least one covering element comprises at least one of an optical property of refraction, absorption, diffusion, and reflection.

18. The field configurable lighting assembly of claim 12, wherein the one covering element is made of plastic, metal, glass, rubber, paper, wood, felt, recycled material, recycled PET felt, or any combination thereof.

19. The field configurable lighting assembly of claim 12, wherein the at least one covering element and the reflector are integral with or detachably coupled to the at least one linear supporting element.

20. The field configurable lighting assembly of claim 1 comprising two linear support elements configured to support opposing edges of a reflector at an elevation above the ceiling grid plane.

21. The field configurable lighting assembly of claim 1, wherein an edgelit optical element is positioned horizontally, vertically or obliquely.

22. The field configurable lighting assembly of claim 1, wherein an optical element is edgelit by the at least one LED light source.

23. The field configurable lighting assembly of claim 1, wherein the at least one LED light source is proximate to one input face of a single optical element.

24. The field configurable lighting assembly of claim 1, wherein two independently electrically addressable LED light sources are each positioned to input light into different input faces of a common optical element.

25. The field configurable lighting assembly of claim 1, wherein light from the at least one LED light source is input into an input face of an edgelit optical element and output from an adjacent face of the edgelit optical element.

26. The field configurable lighting assembly of claim 1, wherein a portion of light from an LED light source is reflected by the reflector within the optical cavity.

27. The field configurable lighting assembly of claim 1, wherein a portion of light emitted from the at least one optical element is projected below the reflector and a portion is incident upon the reflector.

28. The field configurable lighting assembly of claim 1, wherein light distribution emitted from the field configurable lighting assembly is non-lambertian and has a light distribution shape that is; batwing, asymmetric, double asymmetric, narrow or medium.

29. The field configurable lighting assembly of claim 1, wherein the edgelit optical element is a low clarity edgelit diffuser or high clarity light guide.

30. The field configurable lighting assembly of claim 1, wherein the at least one optical assembly is housed in a module or cartridge configured to be removable from the at least one linear support element.

31. The field configurable lighting assembly of claim 1, wherein the at least one optical element is supported by the at least one linear profile support element at an angle parallel, perpendicular or oblique to the ceiling grid plane.

32. The field configurable lighting assembly of claim 1, wherein the at least one optical element comprises a TIR optic configured to receive and transmit light from the at least one LED light source.

33. The field configurable lighting assembly of claim 1, wherein the at least one optical element has a cross sectional profile shape that is rectangular, triangular, arcuate, or any combination thereof.

34. The field configurable lighting assembly of claim 1, wherein the at least one optical assembly further comprises a diffusing outer lens positioned to redirect light from the at least one optical element.

35. The field configurable lighting assembly of claim 1, wherein a height of the elongate body of the at least one linear support element is less than a height of a ceiling grid T-Bar.

36. The field configurable lighting assembly of claim 1, wherein the at least one linear support element further comprises a clip, bracket, or latch for attachment to the mounting T-Bar.

37. The field configurable lighting assembly of claim 1, wherein a reflector is one of a standard ceiling panel, an acoustic ceiling panel, a decorative tile, a planar reflective panel or a non-planar reflective panel.

38. The field configurable lighting assembly of claim 1, wherein a reflector includes a reflective surface having one of an optical property; specular, diffuse, light redirecting, and surface textured.

39. The field configurable lighting assembly of claim 1, wherein a support portion of a linear support element is configured to replicate a structure of a horizontal portion of a ceiling grid T-Bar.

40. The field configurable lighting assembly of claim 39, wherein the support portion of a the linear profile support element is configured to replicate a structure of a horizontal portion of a 9/16″ slot style T-Bar.

41. The field configurable lighting assembly of claim 1, wherein the at least one linear support element has a 3-dimensional shape of a cross-sectional profile area extended linearly into a third axis and configured to provide:
i) a central structural portion to which other portions are connected;
ii) a mounting portion that extends from a top of a vertical structural portion and mounts over a vertical portion of the mounting T-Bar;
iii) at least one utility component supporting portion integral with the central structural portion; and
iv) at least one reflector supporting portion integral with the at least one central structural portion or the at least one utility component supporting portion.

42. A field configurable lighting assembly that is supported within and assembled at a site of a ceiling grid system, wherein the ceiling grid system comprises an array of T-bar cells having ceiling grid T-bars with vertical and horizontal portions, wherein a plane containing the horizontal portions of the ceiling grid T-bars defines a ceiling grid plane, the field configurable lighting assembly comprising:
a) a T-bar cell within the T-bar grid array that provides structural integrity to the lighting assembly;
b) at least one linear lighting module arranged within the T-bar cell and supported on vertical portions of a pair of laterally (mounting) spaced apart T-bars of the T-bar cell, the at least one linear lighting module comprising an optical assembly having at least one LED light source and at least one printed circuit board; and;
c) a reflector configured to be arranged on horizontal portions of at least a pair of laterally spaced apart T-bars of the T-bar cell; and
wherein the reflector is configured to form an optical cavity that spans at least partially or completely over the T-bar cell and above the ceiling grid plane, and wherein the reflector and the at least one linear lighting module are configured to illuminate a space or a surface above or below the ceiling grid plane at least directly or indirectly.

43. The field configurable lighting assembly of claim 42 installed in tandem with the ceiling grid system.

44. The field configurable lighting assembly of claim 42 installed within a pre-existing ceiling grid system.

45. The field configurable lighting assembly of claim 42 wherein a kit of reflectors and any combination of linear lighting modules, linear lighting module components, or linear lighting module sub-assemblies packaged are transported to the assembly site.

46. The field configurable lighting assembly of claim 42 wherein reflectors for assembly are transported or stored in a stacked configuration.

47. The field configurable lighting assembly of claim 42, wherein the reflector comprises at least a pair of support flanges configured at a pair of laterally opposite edges of the reflector.

48. The field configurable lighting assembly of claim 42, wherein each of the at least one linear lighting module comprises a pair of hooks configured to be supported on vertical portions of the pair of laterally spaced apart T-bars of the T-bar cell.

49. The field configurable lighting assembly of claim 42, wherein the optical assembly further comprises at least one optical element.

50. The field configurable lighting assembly of claim 42, further comprises at least one ceiling panel configured to cover a gap of the T-bar cell when the reflector partially spans over the T-bar cell.

51. The field configurable lighting assembly of claim 42, wherein the at least one linear lighting module is arranged centrally or non-centrally with respect to the central optical cavity.
